(19) United States
(12) Patent Application Publication
(10) Pub. No.: US 2026/0066374 A1
(43) Pub. Date: Mar. 5, 2026

(54) ELECTRIC VEHICLE THERMAL MANAGEMENT SYSTEM WITH THERMAL CONTROL POUCHES

(71) Applicant: Taiga Motors Inc., Lasalle (CA)

(72) Inventors: Michael Rempel BOSCHMAN, Montreal (CA); Charles-Etienne FAUBERT-MYRE, Montreal (CA); Amiel SUAREZ, Montreal (CA)

(73) Assignee: Taiga Motors Inc., Lasalle (CA)

(21) Appl. No.: 19/180,243

(22) Filed: Apr. 16, 2025

Related U.S. Application Data
(60) Provisional application No. 63/635,338, filed on Apr. 17, 2024.

(51) Int. Cl. H01M 10/613; B60L 50/60; H01M 10/625; H01M 10/6568

(52) U.S. Cl. CPC H01M 10/613; B60L 50/60; H01M 10/625; H01M 10/6568; B60L 2200/24; B60L 2240/545; B60L 2240/547

(57) ABSTRACT

One aspect provides a battery cooling pouch including a first thin film sheet defined as a first cooling fin having a first major surface to contact a battery cell, a second thin film sheet defined as a second cooling fin having a first major surface, and a panel insert of a polymeric material, wherein perimeter edges of the first and second thin film sheets are sealed to confine the panel insert between the first and second thin film sheets, the panel insert having a major surface defining coolant flow grooves exposed to the first thin film sheet to form coolant flow channels. The cooling pouch includes at least one interior seal between at least a portion of the first thin film sheet and the major surface of the panel insert to direct a coolant fluid through the coolant flow channels.

### CROSS-REFERENCE TO RELATED APPLICATION

The present application claims priority to U.S. Provisional Patent Application Ser. No. 63/635,338 filed on Apr. 17, 2024, the entire contents of which are hereby incorporated by reference.

### TECHNICAL FIELD

The present disclosure relates generally to electric vehicles, including electric powersports vehicles, and, more particularly, to examples of a thermal management system for an electric vehicle.

### BACKGROUND

Electric vehicles (EVs), including electric powersport vehicles, have rechargeable batteries to store energy and provide power for the vehicle. The battery is charged/recharged directly from a power grid via a charging station and/or by regenerative braking which converts some of the vehicle's kinetic energy into electrical energy. The battery is discharged to power an electric motor of the vehicle and other accessories. The flow of current during the charging and discharging processes creates heat in the battery cells.

### SUMMARY

One example provides a battery cooling pouch including a first thin film sheet defined as a first cooling fin having a first major surface to contact a battery cell, a second thin film sheet defined as a second cooling fin having a first major surface, and a panel insert of a polymeric material, wherein perimeter edges of the first and second thin film sheets are sealed to confine the panel insert between the first and second thin film sheets, the panel insert having a major surface defining coolant flow grooves exposed to the first thin film sheet to form coolant flow channels. The cooling pouch includes at least one interior seal between at least a portion of the first thin film sheet and the major surface of the panel insert to direct a coolant fluid through the coolant flow channels.

One example provides an electric vehicle including a battery, the battery including a plurality of battery cells, and a plurality of cooling pouches interleaved with the plurality of battery cells. Each cooling pouch has opposing first and second thin-film walls, at least one of the first and second thin-film walls of each cooling pouch being in contact with at least one battery cell. A pump is to circulate a coolant fluid through the cooling pouches at a selected operating pressure level to apply the selected operating pressure via the cooling pouches to at least one battery cell in contact there with.

One example provides a method of operating a thermal management system of an electric vehicle. The method includes circulating, via a pump, a coolant fluid through a plurality of cooling flow channels in a cooling pouch of the thermal management system, wherein at least a portion of the cooling flow channels are formed by a flexible outer panel of the cooling pouch. The flexible outer panel is in direct contact with a battery cell for applying a selected operating pressure level to the battery cell. The method further includes determining an identified battery operating parameter and controlling operation of the pump at least in part on a basis of the identified battery operating parameter to maintain the selected operating pressure level during operation of the electric vehicle.

One example provides an electric vehicle including a battery having a plurality of battery cells and a plurality of cooling pouches interleaved with the plurality of battery cells. Each cooling pouch includes opposing first and second thin-film walls, a panel insert comprising fluid grooves positioned between the first and second thin-film walls for defining coolant flow channels for a coolant fluid, and at least one interior seal between each of the first and second thin film sheets and the panel insert to avoid cross-flow of the coolant fluid between adjacent cooling flow channels of the cooling pouch. A foam strip is positioned between a battery cell and a respective cooling pouch in a location of the interior seal. A pump is to circulate the coolant fluid through the cooling pouches.

Additional and/or alternative features and aspects of examples of the present technology will become apparent from the following description and the accompanying drawings.

### BRIEF DESCRIPTION OF THE DRAWINGS

FIG. 1A is a side plan view of a snowmobile, according to one example.

FIG. 1B is a side plan view of a snowmobile, according to one example.

FIG. 1C is a perspective view of a mid-bay of the snowmobile of FIGS. 1A and 1B, according to one example.

FIG. 2 is a block and schematic diagram generally illustrating a thermal management system, according to one example.

FIG. 3 is a perspective view of one example of a battery cooling pouch.

FIG. 4 is one example of an exploded view of the pouch of FIG. 3.

FIG. 5 is a partial cross-sectional view illustrating one example of an edge seal.

FIG. 6 is a partial cross-sectional view illustrating another example of an edge seal.

FIG. 7 is one example of an outer panel.

FIG. 8 is another example of an outer panel.

FIG. 9 is another example of an outer panel.

FIG. 10 is another example of a battery cooling pouch assembly.

FIG. 11 is one example of an exploded view of the pouch of FIG. 10.

FIG. 12 is a cross-sectional view of the panel insert of FIGS. 4 and 11.

FIG. 13 is another example of a battery cooling pouch assembly.

FIG. 14 is an exploded perspective view of one example of a battery module subassembly.

FIG. 15 is a perspective view illustrating one example of a battery module.

FIG. 16 is an exploded view illustrating one example of the battery module of FIG. 13.

FIGS. 17-19 are enlarged cross-sectional views of a manifold system.

FIG. 20 is a block and schematic diagram generally illustrating a battery module, according to one example,

FIG. 21 is a block and schematic diagram generally illustrating a cross-sectional view of a portion of a battery module subassembly of a battery module, according to one example.

FIG. 22 is a block and schematic diagram generally illustrating a cross-sectional view of a portion of a battery module subassembly of a battery module, according to one example.

FIG. 23 is a block and schematic diagram generally illustrating a cross-sectional view of a portion of a battery module subassembly of a battery module, according to one example.

FIG. 24 is a perspective view of a cooling pouch, according to one example.

FIG. 25 is a perspective view of a cooling pouch, according to one example.

FIGS. 26A and 26B are block and schematic diagrams generally illustrating a cross-sectional view of a portion of a battery module, according to one example.

FIG. 27 is a block and schematic diagram generally illustrating a thermal management system, according to one example.

FIG. 28 is a flow diagram generally illustrating a method of operating a thermal management system, according to one example.

FIGS. 29A and 29B are perspective views of a battery module, according to one example.

FIG. 29C is an exploded perspective view of the battery module, according to one example.

FIG. 29D is a block and schematic diagram generally illustrating a cross-sectional view of a battery module, according to one example.

FIG. 29E is an exploded perspective view of a cooling pouch, according to one example.

FIG. 30A is a perspective view illustrating a cooling pouch, according to one example.

FIG. 30B is an exploded perspective view of a cooling pouch, according to one example.

FIG. 30C is a perspective cut-away view of a cooling pouch, according to one example.

FIG. 31 is a flow diagram generally illustrating a method of operating a thermal management system, according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

The systems and methods described herein may be suitable for electric off-road vehicles and electric powersport vehicles. Non-limiting examples of electric off-road/powersport vehicles include snowmobiles, motorcycles, watercraft such as boats and personal watercraft (PWC), all-terrain vehicles (ATVs), and utility task vehicles (UTVs) (e.g., side-by-side).

EVs typically employ rechargeable lithium ion battery cells. The performance and lifetime of lithium ion battery cells is greatly dependent on temperature. When overheated, the battery cells can experience accelerated deterioration, cell damage, and other undesirable effects. Also, when exposed to very low temperatures, the operating efficiency and power capacity of the cells is decreased. In addition to overall battery temperature, uneven temperature distribution within lithium ion battery cells can lead to localized cell deterioration, uneven battery cell aging, poor voltage uniformity, and a reduction in battery life. Such uneven temperature distribution may result from variable current in a cell, non-uniform cooling, thermal conductivity of an associated battery case/enclosure, and placement of anodes and cathodes, for example To improve operational efficiency and battery life, it is important for the operating temperatures of lithium ion battery cells of rechargeable battery systems to be well-controlled and maintained within a desired temperature range (e.g., a relatively constant temperature with very low temperature deviations).

Volumetric expansion and contraction of battery cells during operation is also a factor in the performance and degradation of lithium-ion battery cells. If not addressed, such expansion and contraction can lead to delamination of battery cell layers, resulting in performance degradation and decreased battery life. It has been shown that application of external pressure to lithium-ion battery cells may help to reduce the impacts of battery cell expansion/contraction and extend battery cell operating life.

The present disclosure provides examples of a thermal management system for an EV, where the thermal management system includes flexible, lightweight thermal control pouches which are interleaved with battery cells of a rechargeable battery pack of the EV. In examples, the thermal control pouches include flexible outer panels which are in direct and substantially uniform contact with battery cells surfaces. Pressurized thermal transfer fluid is circulated through the thermal control pouches to transfer thermal energy to/from the battery cells to provide temperature control of the battery cells, and to apply substantially uniform external pressure via the flexible outer panels to the battery cell surfaces to reduce the adverse effects of battery cell expansion/contraction. In examples, the thermal management system may control pressure applied to the battery cells via the thermal transfer fluid to account for changes in the battery cells during operation and over their lifetime. Consistent temperature and pressure control of battery cells improves battery cell performance and battery life.

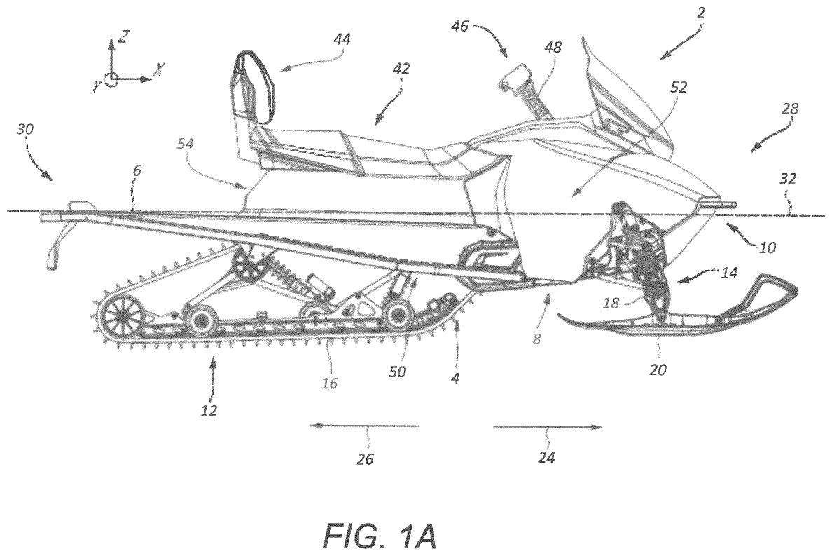

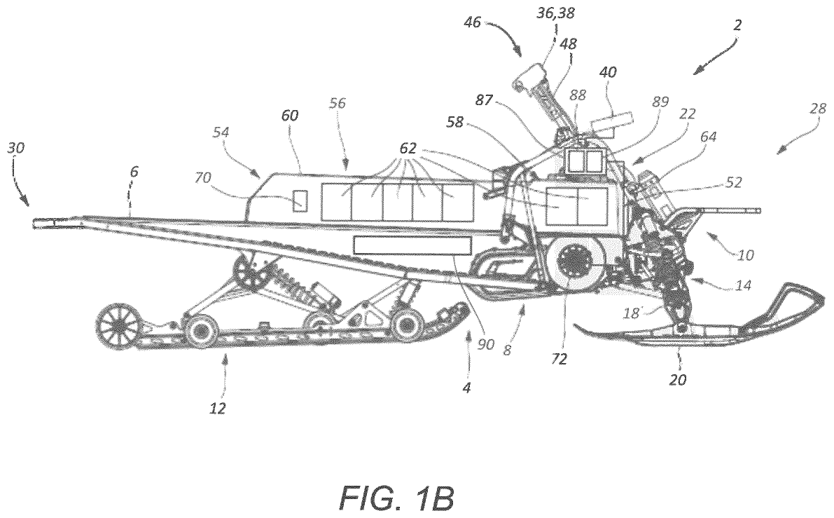

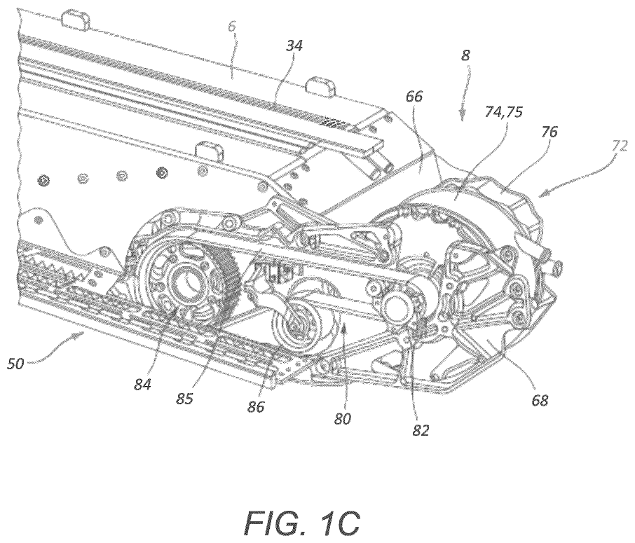

FIG. 1A illustrates a side plan view of a snowmobile 2, according to an embodiment, and FIG. 1B illustrates another side plan view of the snowmobile 2 with several body panels and other components removed so that the interior of the snowmobile 2 may be viewed. As described herein, snowmobile 2 represents an example of an EV having a thermal management system 90, in accordance with examples of the present disclosure, which employs thermal control panels 100 interleaved with a plurality of battery cells (e.g., lithium-on pouch style battery cells) to control the temperature of the battery cells and to apply pressure to the battery cells to reduce the occurrence of delamination of the battery cells over time. Examples of thermal management system 90 and thermal control panels 100 will be described in greater detail herein. Although illustrated as electric vehicle 2, thermal management system 90 and thermal control panels 100, in accordance with the present disclosure, are suitable for use in any number of types of electric vehicles, including cars, trucks, an various type of electric powersport vehicles such as personal watercraft (PWC), all-terrain vehicles (ATVs), and utility task vehicles (UTVs), including side-by-side vehicles (S×S), for example.

In examples, snowmobile 2 includes a frame 4, which may also be referred to as a “chassis” or “body”, that provides a load bearing framework for the snowmobile 2. In the illustrated embodiment, the frame 4 includes a longitudinal tunnel 6, a mid-bay 8 (or “bulkhead”) coupled forward of the tunnel 6, and a front sub-frame 10 (or “front brace”) coupled forward of the mid-bay 8. In some implementations, the mid-bay 8 may form part of the front sub-frame 10.

The snowmobile 2 also includes a rear suspension assembly 12 and a front suspension assembly 14 to provide shock absorption and improve ride quality. The rear suspension assembly 12 may be coupled to the underside of the tunnel 6 to facilitate the transfer of loads between the rear suspension assembly 12 and the tunnel 6. The rear suspension assembly 12 supports a drive track 16 having the form of an endless belt for engaging the ground (e.g., snow) and propelling the snowmobile 2. The rear suspension assembly may include, inter alia, one or more rails and/or idler wheels for engaging with the drive track 16, and one or more control arms and damping elements (e.g., elastic elements such as coil and/or torsion springs forming a shock absorber) connecting the rails to the tunnel 6. The front suspension assembly 14 includes two suspension legs 18 coupled to the front sub-frame 10 and to respective ground engaging front skis 20 (only one suspension leg 18 and ski 20 are visible in FIGS. 1A and 1B). Each of the suspension legs 18 may include two A-frame arms connected to the front sub-frame 10, a damping element (e.g., an elastic element) connected to the front sub-frame 10, and a spindle connecting the A-frame arms and the damping element to a respective one of the skis 20. The suspension legs 18 transfer loads between the skis 20 and the front sub-frame 10. In the illustrated embodiment, the frame 4 also includes an over structure 22 (shown in FIG. 1B), that may include multiple members (e.g., tubular members) interconnecting the tunnel 6, the mid-bay 8 and/or the front sub-frame 10 to provide additional rigidity to the frame 4. However, as discussed elsewhere herein, the over structure 22 may be omitted in some embodiments.

The snowmobile 2 may move along a forward direction of travel 24 and a rearward direction of travel 26 (shown in FIG. 1A). The forward direction of travel 24 is the direction along which the snowmobile 2 travels in most instances when displacing. The rearward direction of travel 26 is the direction along which the snowmobile 2 displaces only occasionally, such as when it is reversing. The snowmobile 2 includes a front end 28 and a rear end 30 defined with respect to the forward direction of travel 24 and the rearward direction of travel 26. For example, the front end 28 is positioned ahead of the rear end 30 relative to the forward direction of travel 24. The snowmobile 2 defines a longitudinal center axis 32 that extends between the front end 28 and the rear end 30. Two opposing lateral sides of the snowmobile 2 are defined parallel to the center axis 32. The positional descriptors “front”, “rear” and terms related thereto are used in the present disclosure to describe the relative position of components of the snowmobile 2. For example, if a first component of the snowmobile 2 is described herein as being in front of, or forward of, a second component, then the first component is closer to the front end 28 than the second component. Similarly, if a first component of the snowmobile 2 is described herein as being behind, or rearward of, a second component, then the first component is closer to the rear end 30 than the second component. The snowmobile 2 also includes a three-axes frame of reference that is displaceable with the snowmobile 2, where the Z-axis is parallel to the vertical direction, the X-axis is parallel to the center axis 32, and the Y-axis is parallel to the lateral direction.

The snowmobile 2 is configured to carry one or more riders, including a driver (sometimes referred to as an “operator”) and optionally one or more passengers. In the illustrated example, the snowmobile 2 includes a straddle seat 42 to support the riders. Optionally, the straddle seat 42 includes a backrest 44. The operator of the snowmobile 2 may steer the snowmobile 2 using a steering mechanism 46 (e.g., handlebars), which are operatively connected to the skis 20 via a steering shaft 48 to control the direction of the skis 20. The tunnel 6 may also include or be coupled to footrests 50 (also referred to as “running boards”), namely left and right footrests each sized for receiving a foot of one or more riders sitting on the straddle seat 42.

Referring to FIG. 1B, the snowmobile 2 is electrically propelled by an electric powertrain 52. The powertrain 52 includes an electric battery 54 (also referred to as a “battery pack”) and an electric motor 72. The battery 54 is electrically connected to the motor 72 to provide electric power to the motor 72. The motor 72, in turn, is drivingly coupled to the drive track 16 to propel the snowmobile 2 across the ground. In other embodiments, the snowmobile 2 may also or instead be propelled by a powertrain including an internal combustion engine. For example, the motor 72 may also or instead be an internal combustion engine.

The battery 54 may include a battery enclosure 60 that houses one or more battery modules 62. The battery enclosure 60 may support the battery modules 62 and protect the battery modules 62 from external impacts, water and/or other hazards or debris. Each battery module 62 may contain one or more battery cells, such as pouch cells, cylindrical cells and/or prismatic cells, for example. In some implementations, the battery cells are rechargeable lithium-ion battery cells. The battery 54 may also include other components to help facilitate and/or improve the operation of the battery 54, including temperature sensors to monitor the temperature of the battery cells, voltage sensors to measure the voltage of one or more battery cells, current sensors to implement column counting to infer the state of charge (SOC) of the battery 54, and/or thermal channels that circulate a thermal fluid to control the temperature of the battery cells. In some implementations, the battery 54 may output electric power at a voltage of between 300 and 800 volts, for example. The snowmobile 2 may also include a charger 64 to convert AC to DC current from an external power source to charge the battery 54. The charger 64 may include, or be connected to, a charging port positioned forward of the straddle seat 42 to connect to a charging cable from an external power source. In some implementations, the charging port is covered by one or more protective flaps (e.g., made of plastic and/or rubber) to protect the charging port from water, snow and other debris.

In some implementations, the battery 54 may be generally divided into a tunnel battery portion 56 and a mid-bay battery portion 58. The tunnel battery portion 56 may be positioned above and coupled to the tunnel 6. As illustrated, the straddle seat 42 is positioned above the tunnel battery portion 56 and, optionally, the straddle seat 42 may be supported by the battery enclosure 60 and/or internal structures within the battery 54. The mid-bay battery portion 58 extends into the mid-bay 8 and may be coupled to the mid-bay 8 and/or to the front sub-frame 10. The tunnel battery portion 56 and the mid-bay battery portion 58 may share a single battery enclosure 60, or alternatively separate battery enclosures. In the illustrated example, the tunnel battery portion 56 and the mid-bay battery portion 58 each include multiple battery modules 62 that are arranged in a row and/or stacked within the battery enclosure 60.

It should be noted that other shapes, sizes and configurations of the battery 54 are contemplated. For example, the battery 54 may include multiple batteries that are interconnected via electrical cables. In some embodiments, the battery enclosure 60 may be a structural component of the snowmobile 2 and may form part of the frame 4. For example, the battery enclosure 60 may be coupled to the front sub-frame 10 to transfer loads between the front sub-frame 10 and the tunnel 6. The battery enclosure 60 may be formed from a fiber composite material (e.g., a carbon fiber composite) for additional rigidity. Optionally, in the case that the battery enclosure 60 is a structural component of the snowmobile 2, the over structure 22 may be omitted.

FIG. 1C is a perspective view of the mid-bay 8 of the snowmobile 2. As illustrated, the motor 72 is disposed in a lower portion of the mid-bay 8, below the mid-bay battery portion 58 and forward of a wall 66 defining a front end of the tunnel 6. The motor 72 may be mounted to a transmission plate 68 that is supported between the tunnel 6 and the front sub-frame 10 to help support the motor 72 within the mid-bay 8.

In the illustrated embodiment, the motor 72 is a permanent magnet synchronous motor having a rotor 74 and stator 75. The motor 72 also includes power electronics module 76 (sometimes referred to as an inverter) to convert the direct current (DC) power from the battery 54 to alternating current (AC) power having a desired voltage, current and waveform to drive the motor 72. In some implementations, the power electronics module 76 may include one or more capacitors to reduce the voltage variations between the high and low DC voltage leads, and one or more electric switches (e.g., insulated-gate bipolar transistors (IGBTs)) to generate the AC power. In some implementations, the motor 72 has a maximum output power of between 90 kW and 135 kW. In other implementations, the motor 72 has a maximum output power greater than 135 kW.

In some implementations, the motor 72 may include sensors configured to sense one or more parameters of the motor 72. The sensors may be implemented in the rotor 74, the stator 75 and/or the power electronics module 76. The sensors may include a position sensor (e.g., an encoder or resolver) to measure a position and/or rotational speed of the rotor 74, and/or a speed sensor (e.g., a revolution counter) to measure the rotational speed of the rotor 74. Alternatively or additionally, the sensors may include a torque sensor to measure an output torque from the motor 72 and/or a current sensor (e.g., a Hall effect sensor) to measure an output current from the power electronics module 76.

Other embodiments of the motor 72 are also contemplated. For example, the power electronics module 76 may be integrated into the housing or casing of motor 72, as shown in FIG. 1C. However, the power electronics module 76 may also, or instead, be provided externally to the housing or casing of motor 72. In some embodiments, the motor 72 may be a type other than a permanent magnet synchronous motor. For example, the motor 72 may instead be a brushless direct current motor.

The motor 72 may convert the electric power output from the battery 54 into motive power that is transferred to the drive track 16 via a drive transmission 80. The drive transmission 80 engages with a motor drive shaft 82 of the motor 72. The motor drive shaft 82 may extend laterally through an opening in the transmission plate 68. The drive transmission 80 includes a track drive shaft 84 that extends laterally across the tunnel 6. The motor drive shaft 82 and the track drive shaft 84 may extend parallel to each other along transverse axes of the snowmobile 2 and may be spaced apart from each other along the longitudinal axis 32. In the illustrated embodiment, the motor drive shaft 82 is operably coupled to the track drive shaft 84 via a drive belt 85. Sprockets on the motor drive shaft 82 and the track drive shaft 84 may engage with lugs on the drive belt 85. A drive belt idler pulley 86 may also be implemented to maintain tension on the drive belt 85. In other embodiments, another form of linkage such as a drive chain, for example, may operatively connect the motor drive shaft 82 and the track drive shaft 84.

In operation, torque from the motor 72 is transferred from the motor drive shaft 82 to the track drive shaft 84 via the drive belt 85. The track drive shaft 84 includes one or more sprockets (not shown) that engage with lugs on the drive track 16, thereby allowing the track drive shaft 84 to transfer motive power to the drive track 16. It will be understood that the motor 72 may be operated in two directions (i.e., rotate clockwise or counter-clockwise), allowing the snowmobile 2 to travel in the forward direction of travel 24 and in the rearward direction of travel 26. In some implementations, the drive track 16 and the snowmobile 2 may be slowed down via electrical braking (e.g., regenerative braking) implemented by the motor 72 and/or by a mechanical brake (e.g., a disc brake) connected to one of the track drive shaft 84 or the motor drive shaft 82.

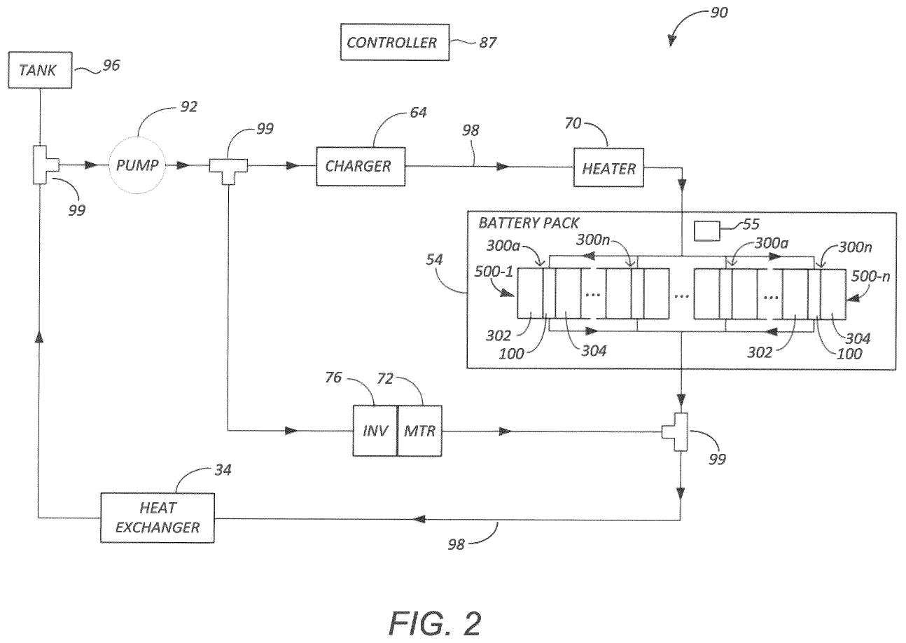

The snowmobile 2 may include a heat exchanger 34 that is coupled to, or integrated with, the tunnel 6. The heat exchanger 34 may form part of a thermal management system to control the temperature of the battery 54, the motor 72 and the charger 64, for example. The heat exchanger may include channels to carry a thermal fluid along a portion of the tunnel 6. During operation of the snowmobile 2, the heat exchanger 34 may be exposed to snow and cold air circulating in the tunnel 6 that cools the thermal fluid. The thermal fluid may then be pumped through thermal channels in the battery 54, the motor 72 and/or the charger 64, for example, to cool those components. In some implementations, the thermal management system of the snowmobile 2 may also include a heater 70 (shown in FIG. 2) to heat the thermal fluid and warm the battery 54. Warming the battery 54 may be useful if the snowmobile 2 has been left for an extended period in a cold environment. In such a case, the temperature of the battery cells in the battery modules 62 may fall to a level where high power is limited from being drawn from the battery 54. Warming the battery 54 may bring the battery cells back into an efficient operating regime. In some implementations, the heater 70 is disposed within the battery enclosure 60.

Referring again to FIG. 1B, one or more controllers 87 (referred to hereinafter in the singular) and an instrument panel 36 are part of a control system for controlling operation of the snowmobile 2. The instrument panel 36 allows an operator of the snowmobile 2 to generate user inputs and/or instructions for the snowmobile 2. The controller 87 is connected to the instrument panel 36 to receive the instructions therefrom and perform operations to implement those instructions. In the illustrated embodiment, the instrument panel 36 is provided on the steering mechanism 46 and the controller 87 is disposed within the interior of the snowmobile 2, but this need not always be the case.

The instrument panel 36 includes an accelerator 38 (also referred to as a “throttle”) to allow an operator to control the power generated by the powertrain 52. For example, the accelerator 38 may include a lever to allow the operator to selectively generate an accelerator signal. The controller 87 is operatively connected to the accelerator 38 and to the motor 72 to receive the accelerator signal and produce a corresponding output from the motor 72. In some implementations, the accelerator signal is mapped to a torque of the motor 72. When the controller 87 receives an accelerator signal from the accelerator 38, the controller 87 maps the accelerator signal to a torque of the motor 72 and controls the power electronics module 76 to produce that torque using feedback from sensors in the motor 50. The mapping of the accelerator signal to an output from the motor 72 may be based on a performance mode of the snowmobile 2 (e.g., whether the snowmobile 2 is in a power-saving mode, a normal mode or a high-performance mode). In some examples, the mapping of the accelerator signal to an output from the motor 72 may be based on current operating conditions of the powertrain 52 (e.g., temperature of the battery 54 and/or motor 72, state of charge of the battery 54, etc.). In still other examples, the mapping of the accelerator signal to an output from the motor 72 may be user configurable, such that a user may customize an accelerator position to motor output mapping.

In addition to the accelerator 36, the instrument panel 34 may include other user input devices (e.g., levers, buttons and/or switches) to control various other functionality of the snowmobile 2. These user input devices may be connected to the controller 87, which executes the instructions received from the user input devices. Non-limiting examples of such user input devices include a brake lever to implement mechanical and/or electrical braking of the snowmobile 2, a reverse option to propel the snowmobile 2 in the rearward direction of travel 26, a device to switch the snowmobile 2 between different vehicle states (e.g., “off”, “neutral” and “drive” states), a device to switch the snowmobile 2 between different performance modes, a device to switch between regenerative braking modes (e.g. “off”, “low” and “high” modes) and a device to activate heating of handgrips of the steering mechanism. The snowmobile 2 also includes a display screen 40 connected to the controller 87. The display screen 40 may be provided forward of the steering mechanism 46, or in any other suitable location depending on the design of the snowmobile 2. The display screen 40 displays information pertaining to the snowmobile 2 to an operator. Non-limiting examples of such information include the current state of the snowmobile 2, the current performance mode of the snowmobile 2, the speed of the snowmobile 2, the state of charge (SOC) of the battery 54, the angular speed of the motor 72, and the power output from the motor 72. The display screen 40 may include a liquid crystal display (LCD) screen, thin-film-transistor (TFT) LCD screen, light-emitting diode (LED) or other suitable display device. In some embodiments, display screen 40 may be touch-sensitive to facilitate operator inputs.

The controller 87 may also control additional functionality of the snowmobile 2. For example, the controller 87 may control a battery management system (BMS) to monitor the SOC of the battery 54 and manage charging and discharging of the battery 54. In another example, the controller 87 may control a thermal management system to manage a temperature of the battery 54, the motor 72 and/or the charger 64 using a thermal fluid cooled by the heat exchanger 34 and/or heated by the heater 70. Temperature sensors in the battery 54 and/or the motor 72 may be connected to the controller 87 to monitor the temperature of these components.

The controller 87 includes one or more data processors 88 (referred hereinafter as “processor 88”) and non-transitory machine-readable memory 89. The memory 89 may store machine-readable instructions which, when executed by the processor 88, cause the processor 88 to perform any computer-implemented method or process described herein. The processor 88 may include, for example, any type of general-purpose microprocessor or microcontroller, a digital signal processing (DSP) processor, an integrated circuit, an application-specific integrated circuit (ASIC), a field programmable gate array (FPGA), a reconfigurable processor, other suitably programmed or programmable logic circuits, or any combination thereof. The memory 89 may include any suitable machine-readable storage medium such as, for example, an electronic, magnetic, optical, electromagnetic, infrared, or semiconductor system, apparatus, or device, or any suitable combination thereof. The memory 89 may be located internally and/or externally to the controller 87.

Although the controller 87 is shown as a single component in FIG. 1B, this is only an example. In some implementations, the controller 87 may include multiple controllers distributed at various locations in the snowmobile 2. For example, the controller 87 may include a vehicle control unit (also referred to as a “body controller”) that is responsible for interpreting the inputs from various other controllers in the snowmobile 2. Non-limiting examples of these other controllers include a motor controller that is part of the power electronics module 76 and a battery management controller that is part of the battery 54. Optionally, separate battery management controllers may be implemented in each of the battery modules 62 to form a distributed battery management system.

Systems and methods are described and shown in the present disclosure in relation to the snowmobile 2, but the present disclosure may also be applied to other types of vehicles, including other types of off-road and powersport vehicles.

FIG. 2 is block and schematic diagram generally illustrating thermal management system 90, according to one example of the present disclosure. Thermal management system 90 includes heat exchanger 34, heater 70, a pump 92, a tank 96 (e.g., a fluid reservoir), a number of fluid circulation paths 98, and a number of controllable valves 99. Thermal management system 90, via pump 92 and fluid circulation paths 98, circulates a thermal transfer fluid through a number of components of electric snowmobile 2, such as battery pack 54, charger 64 (for charging battery pack 54), and motor and inverter 72, 76, to manage the temperatures thereof.

In examples, thermal management system 90 selectively operates valves 99 to form a number of circulation loops to control the components of EV 2 through which thermal transfer fluid is circulated (e.g., based on operating conditions of snowmobile 2). According to examples, heat extracted by the thermal transfer fluid from the components of EV 2 is subsequently removed therefrom by heat exchanger 34 to thereby maintain an operating temperature of the EV components, including battery pack 54, within desired temperature ranges. In some examples, pump 92 produces an output pressure between 10-15 psi. Other output pressures are also contemplated.

In some examples, thermal management system 90, via heater 70, may warm the thermal transfer fluid to warm battery pack 54. For example, heater 70 may be activated when snowmobile 2 is left in cold environments and battery pack 54 drops below a minimum temperature threshold.

In some examples, thermal management system 90 may provide at least two fluid circulation loops: a first loop including pump 92, valves 99, charger 64, battery pack 54, and heat exchanger 34; and a second loop including pump 92, valves 99, inverter 76, electric motor 72, and heat exchanger 34. Controller 87 may operate valves 99 to selectively circulate thermal transfer fluid through only the first fluid circulation loop, only the second fluid circulation loop, or both the first and the second circulation loop simultaneously. Controller 87 may enable the first and/or second fluid circulation loops as required based on the temperature of the components in each loop. For example, the first fluid circulation loop may be enabled when the temperature of charger 64 and/or battery pack 54 exceeds a threshold temperature, and the second fluid circulation loop may be enabled when the temperature of inverter 76 and/or electric motor 72 exceeds a threshold temperature.

In examples, battery pack 54 includes one or more battery modules 500 (sometimes referred to as a battery stack), illustrated as battery modules 500-1 to 500-n, with each battery module 500 including one or more battery module subassemblies 300, illustrated as battery module subassemblies 300a to 300n. In examples, each battery module subassembly 300 includes at least two battery cells 302 and 304 with a thermal control pouch 100 disposed there between. Battery cells 302 and 304 in each battery module subassembly 300 are electrically interconnected, and battery module subassemblies 300 are electrically interconnected to form battery modules 500. Battery modules 500, in turn, are electrically interconnected to form battery pack 54 having desired electrical characteristics (e.g., output voltage and capacity). In some examples, battery pack 54 provides a high voltage output, such as in the range of 300-400 VDC, and in some cases up to 800 VDC. In examples, each battery cell 32 comprises a lithium-ion battery cell, although other suitable battery chemistries and configurations may be employed. In examples, battery pack 54 includes a battery management module 55 which, among other functions, monitors various operating parameters of battery pack 54, including operating parameters of battery modules 500, battery module subassemblies, and battery cells 302 and 304, with operating parameters including parameters such as temperatures, voltages, and current levels, for example.

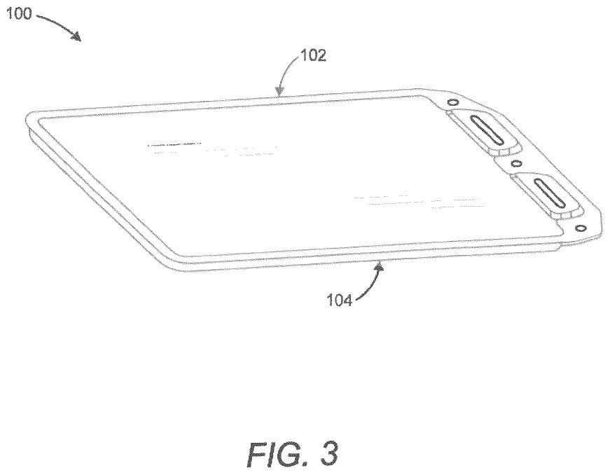

Each battery module subassembly 300 includes at least one thermal control pouch 100 (which may also sometimes referred to as a “thermal pouch”, “thermal management pouch” and “cooling pouch”). In examples, thermal control pouches 100 are part of thermal management system 90. Examples of thermal control pouches 100 are described in herein (e.g., FIGS. 3-13). As also described in greater detail herein, thermal management system 90 circulates pressurized thermal transfer fluid through thermal control pouches 100 to manage the temperature of battery cells 302 and 304, and to apply external pressure to battery cells 302 and 304.

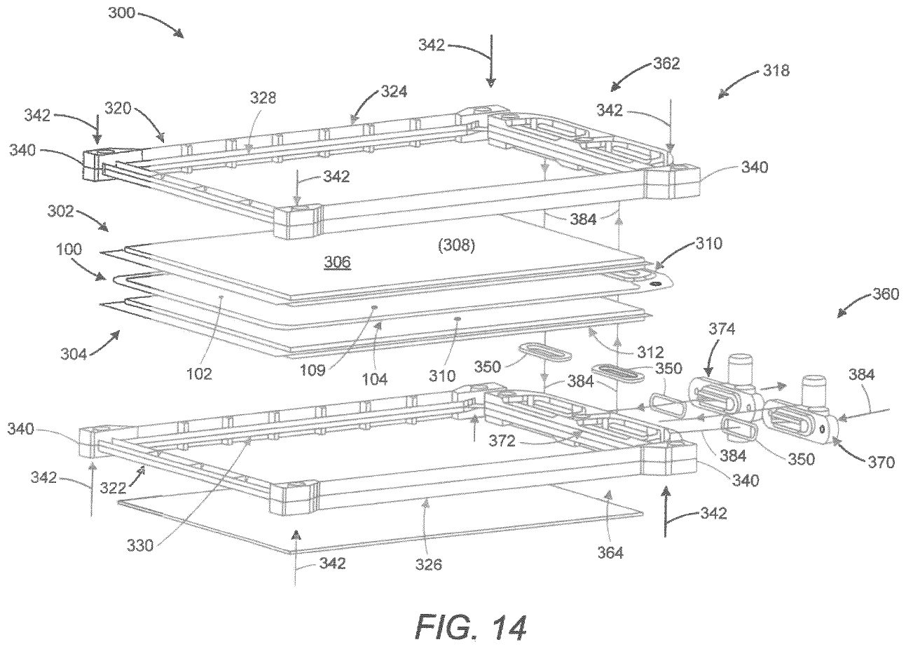

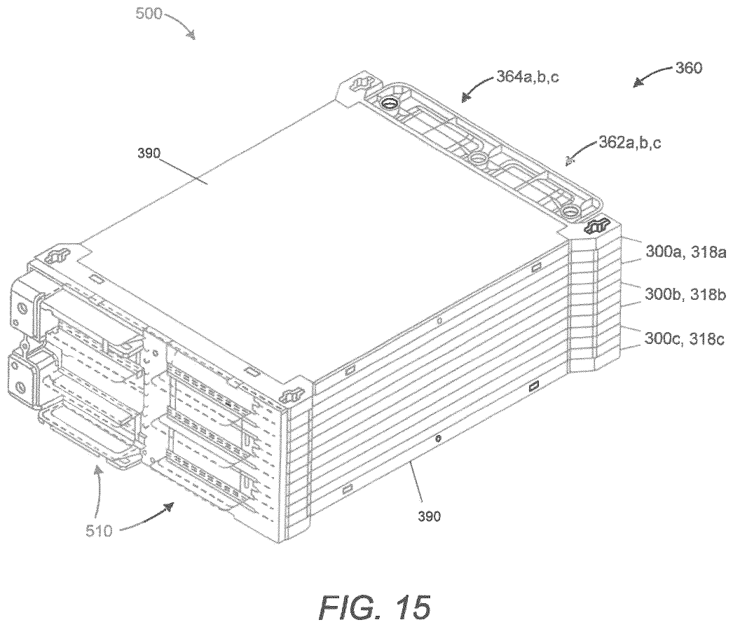

In one example, as will be described in greater detail below, battery cells 302 and 304, and at least one thermal control pouch 100, are arranged in an alternating fashion (interleaved) to form each battery module subassembly 300 (e.g., see FIG. 14), with battery module subassemblies 300, in turn, being arranged in a stack-like fashion to form each battery module 500 (e.g., see FIG. 15). In some examples, snowmobile 2 includes elements of thermal control pouches (also referred to as “cooling pouches”), battery module subassemblies, battery modules, and cooling system arrangements described in U.S. patent application Ser. No. 17/091,777 entitled “Battery Cooling Panel for Electric Vehicles”, the entirety of which is incorporated herein by reference.

Although thermal management system 90 and thermal control pouches 100 may also be employed to transfer heat to the battery cells 302 and 304, thermal management system 90 and thermal control pouches 100 may be employed primarily for cooling of battery cells 302 and 302, and other vehicle components. As such, hereinafter, thermal control panels 100 may also be referred to as “cooling pouches 100” and the thermal transfer fluid may be referred to as a “coolant” or a “coolant fluid”.

FIGS. 3-19 illustrate example implementations of cooling pouches 100, battery modules 31, and battery stacks 30, in accordance with examples of the present disclosure. FIG. 3 is an isometric view generally illustrating cooling pouch 100, according to one example. Cooling pouch 100 includes a first outer panel 102 and an opposing second outer panel 104 with a panel insert 106 (not illustrated in FIG. 3) disposed within a sealed space there between, wherein, as will be described further below, inner surfaces of first and/or second outer panels 102 and 104 and grooves within panel insert 106 together form cooling flow channels (also referred to as “fluid channels”) through which a coolant fluid flows to cool/heat battery cells disposed in contact with exterior surfaces of first and second outer panels 102 and 104. In an alternative example implementation, cooling pouch 100 may not include a panel insert, and instead has cooling flow channels formed by bonding or fusing first outer panel 102 and second outer panel 104 together. Cooling pouch 100 provides for efficient and uniform cooling of a battery cell, such as a pouch battery cell, a cylindrical battery cell and/or a prismatic battery cell. In one example, the battery cooling panel is suitable for use with a lithium ion battery cell in an electric vehicle, such as electric snowmobile 2.

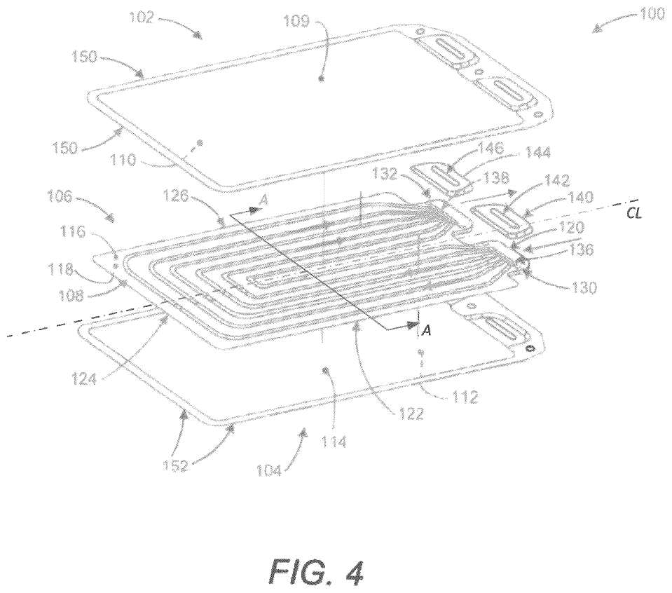

FIG. 4 is an exploded isometric view of the battery cooling pouch 100, according to one example. Battery cooling panel includes a first outer panel 102 and a second outer panel 104. The first outer panel 102 may be defined as a cooling fin, and includes a first major (exterior) surface 109 and an opposing second major (interior) surface 110, where first major surface 109 is configured to contact a battery cell (e.g., a first battery cell). The second outer panel 104, which may also be defined as a cooling fin, includes a first major (exterior) surface 112 and a second major (interior) surface 114, where first major surface 112 may also contact a battery cell (e.g., a second battery cell). In one embodiment, both the first major surface 109 of first outer panel 102 and first major surface 112 of second outer panel 104 are substantially planar. As described further below, first outer panel 102 and second outer panel 104 may be made of flexible, thin film materials that provide flexibility (i.e., non-rigidity) to cooling pouch 100.

Panel insert 106 includes a first major surface 116 and a second surface 118 and includes open grooves 108 which extend at least partially through panel insert 106. In examples, panel insert 106 is made of a polymeric material. In one example, the polymeric material is polyethylene (PE). In another example, the polymeric material is polypropylene. In examples, open grooves 108 are formed or molded in the polymeric material. In other examples, grooves 108 may be formed in another manner such as by cutting, etching or abrading grooves in the surface of the polymeric material. In one example, grooves 108 extend partially through panel insert 106 from first surface 116 toward second surface 118 to be open to interior surface 110 of first outer panel 102. In another example, as illustrated, grooves 108 extend entirely through panel insert 106 between first and second major surface 116 and 118 to be open to both first outer panel 102 and second outer panel 104.

In examples, as will be described in greater detail below, panel insert 106 is positioned between the first outer panel 102 and the second outer panel 104, with first major surface 116 of panel insert 106 facing interior surface 110 of first outer panel 102, and second major surface 118 facing interior surface 114 of second outer panel 104. In examples, as will be described in greater detail below, the first outer panel 102 and the second outer panel 104 operate to enclose the panel insert 106, with interior surface 110 of first outer panel 102 positioned against first major surface 116 of panel insert 106, and interior surface 114 of second outer panel 104 positioned against second major surface 118 of panel insert 106 so as to transform grooves 108 into cooling flow channels 108 within battery cooling pouch 100. In examples, interior surfaces 110 and 114 are sealed along a periphery of cooling pouch 100, and are not sealed against major surfaces 116, 118 of panel insert 106.

In examples, panel insert 106 forms a portion of the inner sidewalls of each flow channel 108 and interior surfaces 110 and 114 of first and second outer panels 102 and 104 form a remaining portion of the inner sidewalls of each cooling flow channel 108. In one example, flow channels 108 may be rectangular in cross-section, with panel insert 106 forming a first pair of opposing sidewalls and interior surfaces 110 and 114 of first and second outer panels 102 and 104 forming a second pair of opposing sidewalls of cooling flow channels 108, where the opposing sidewalls formed by first and second outer panels 102 and 104 (via exterior surfaces 109 and 118) are in contact with battery cells 32. In examples, pump 92 of thermal management system 90 pumps coolant fluid through flow channels 108 to cool (or heat) battery cells 32 of battery pack 54 (e.g., see FIG. 2) during operation of electric snowmobile 2.

In examples, the channels 108 run from an edge of panel insert 106, throughout the panel insert 106, and back to an edge of the panel insert. In one embodiment, panel insert 106 includes an edge 120, 122, 124 and 126. An inlet channel endplate 130 and an outlet channel endplate 132 are located at edge 120. Inlet channel endplate 130 and outlet channel endplate 132 can be separate pieces or be integrally formed with panel insert 106. Channels 108 begin at inlet channel endplate 130, run throughout panel insert 106 (e.g., in a circular, semi-circular, or U-shaped manner) and exit at outlet channel endplate 132. Inlet channel endplate 130 includes an opening 136 to allow coolant fluid to flow into channels 108. Outlet channel endplate 132 includes an opening 138 to allow coolant fluid to exit or flow out of channels 108. In this manner, coolant fluid enters panel insert 106 at inlet channel endplate 130, flows through the channels 108 and/or an interior compartment formed between first and second outer panels 102 and 104, thereby removing excess heat from a battery cell, and exits at outlet channel endplate 132. Inlet channel endplate 130 may also include an endplate cover 140 having an opening 142 that aligns with opening 136. Outlet channel endplate 132 may also include an endplate cover 144 having an opening 146 that aligns with opening 138.

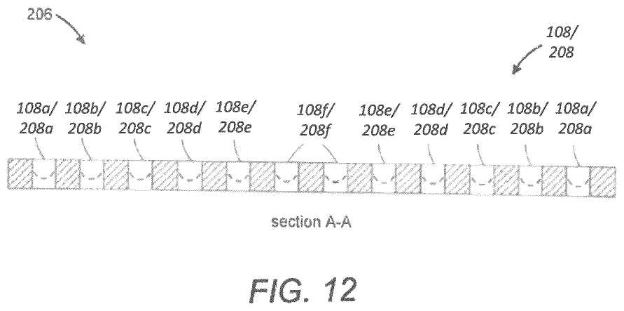

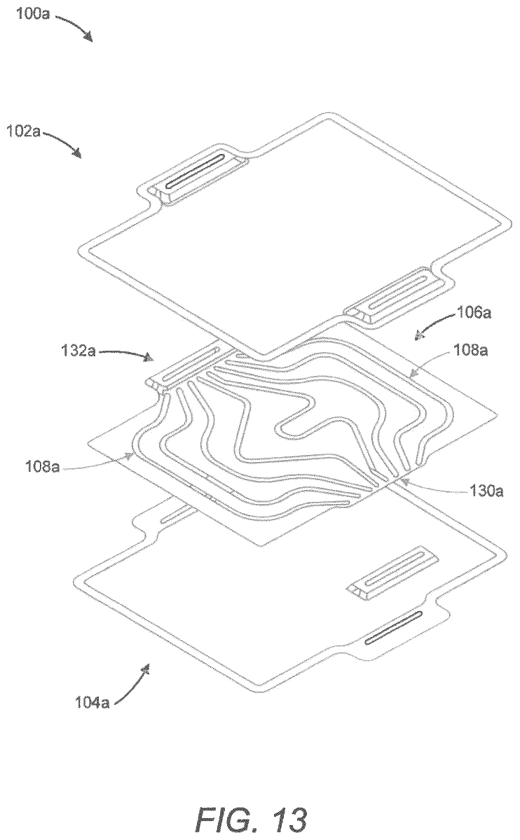

In one example, as illustrated by FIG. 4, cooling flow channels 108 extend in a U-shaped manner about a longitudinal centerline, CL, of panel insert 106 between inlet channel endplate 130 and outlet channel endplate 132, where, as illustrated by arrows, coolant fluid flows within coolant flow channels 108 in a first direction on one side of the longitudinal centerline and in a second direction (opposite the first direction) on the other side of the longitudinal centerline (e.g., see also FIGS. 12 and 22). In other examples, coolant flow channels 108 extend between inlet and outlet channel endplates on opposing ends of panel insert 106 (e.g., see FIG. 13).

First outer panel 102 and second outer panel 104 may be made from a flexible, non-rigid sheet or film of material. The flexible, non-rigid properties of first outer panel 102 and second outer panel 104 may help cooling pouch 100 improve contact with adjacent battery cells, and thereby improve heat transfer between cooling pouch 100 and battery cells. For example, first outer panel 102 and/or second outer panel 104 may conform to the shape of adjacent battery cells to provide a larger contact area for conductive heat transfer. Further, flexible, non-rigid panels 102, 104 may enable the cooling pouch 100 to expand/contract to exert different pressure (i.e. maintain a selected operating pressure) to the battery cells to compensate for thickening/thinning of the battery cells during electrical charging/discharging and over the life of the battery cell. Further, flexible, non-rigid panels may be lighter than rigid alternatives. In one example, the panels 102, 104 are made of a thin film sheet of polymeric material. In one example, the first outer panel 102 is secured to the second outer panel 104 at their outer edges 150, 152, respectively. The first outer panel 102 can be sealed to the second panel 104, for example, by heat sealing, pressure sealing, and/or by using an added adhesive.

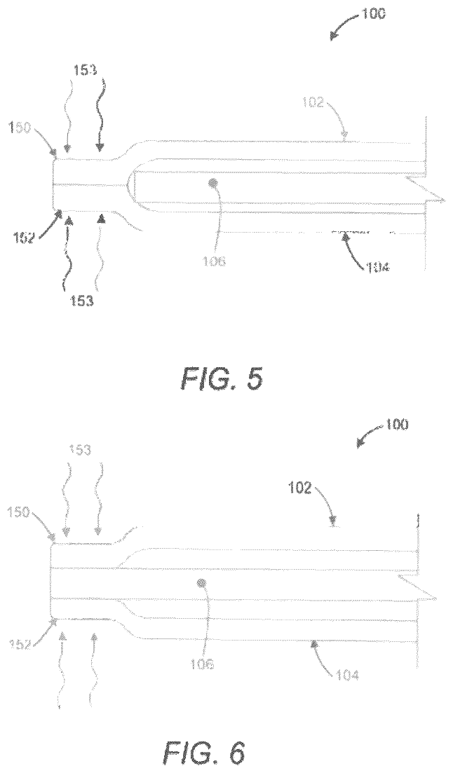

FIG. 5 illustrates an end portion of battery cooling pouch 100 where first outer panel 102 is sealed to second outer panel 104 at outer edges 150, 152 via a mechanical or chemical sealing mechanism, such as a heat-sealing treatment 153 among other possibilities. Panel insert 106 is positioned inside battery cooling pouch 100 and allowed to securely float in between the first outer panel 102 and the second outer panel 104. FIG. 6 illustrates another example at an end portion of battery cooling pouch 100 where first outer panel 102, second outer panel 104 and panel insert 106 are all heat sealed 153 at an outer edge. It is recognized that the first outer panel 102 and the second outer panel 104 may be selectively sealed to panel insert 106 at locations other than near the outer edge of the battery cooling pouch 100.

When first outer panel 102 and second outer panel 104 are sealed about panel insert 106, due to the flexible, non-rigid properties of the sheet material, the sheet material of panels 102,104 may deform so as to conform about parts of panel insert 106 so that once sealed together, the inner surfaces 110 and 114 of first and second outer panels 102 and 104 are securely pressed against the first and second surfaces 116 and 118 of panel insert 106.

The first outer panel 102 and second outer panel 104 when made of a thin film sheet or foil may be formed of a single layer or multiple layers. Advantages of layered thin film sheets include very light weight, ease of manufacture, and being inexpensive for material costs and manufacture. Further advantages include durability and structural soundness.

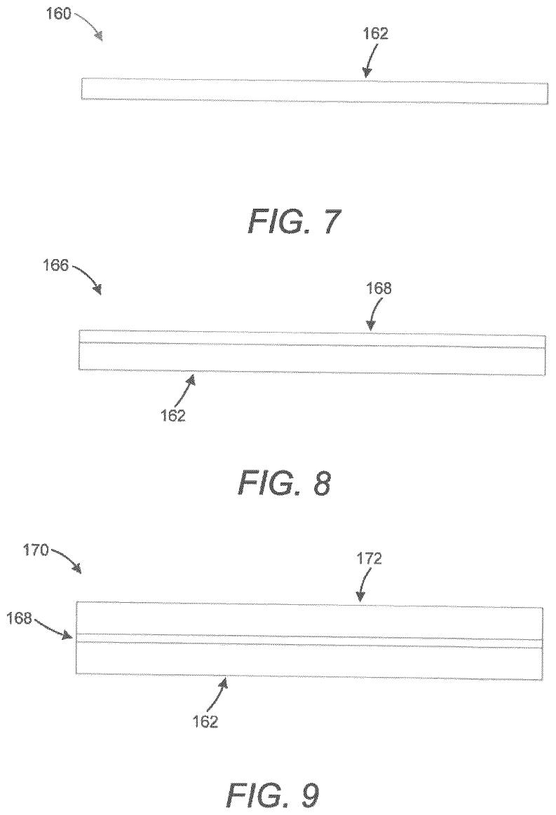

FIG. 7 illustrates at 160 one embodiment of an outer panel sheet formed of a single layer 162 of polymeric material. In one or more examples, the polymeric material is polyethylene, polythene, or polyethylene terephthalate (i.e., a polyester). The thin film sheet can be made of low density or high density materials. In one embodiment, the thin film sheet has a thickness in the range of 5 microns-50 microns, with a weight in the range of 20 grams-200 grams.

FIG. 8 illustrates at 166 one embodiment of an outer panel sheet formed of multiple layers. In this embodiment, the sheet 166 includes layer 162 formed of a polymeric material with a second layer 168 different from the first layer. In one embodiment, the second layer 168 is a metal film or foil layer. In one example, the second layer 168 is an aluminum coated thin film layer. The advantages of second layer 168 include enhanced barrier and structural properties. The second layer 168 may additionally provide a matt surface, a shiny surface or decorative surface properties. The metal film layer is very thin, in a range of 5-50 micrometers.

FIG. 9 illustrates at 170 one embodiment of an outer panel sheet formed of multiple layers. In this embodiment, the sheet 170 includes layer 162, layer 168, and an additional foil or layer 172. Layer 172 can be formed of a metallic or polymeric material. In one example, layer 162 is a polymeric material, layer 168 is a metal layer, and layer 172 is a polymeric material. The layer 172 is an outer foil that can provide additional resistance to scratches, tears and other outside influences such as interfacing with a battery cell.

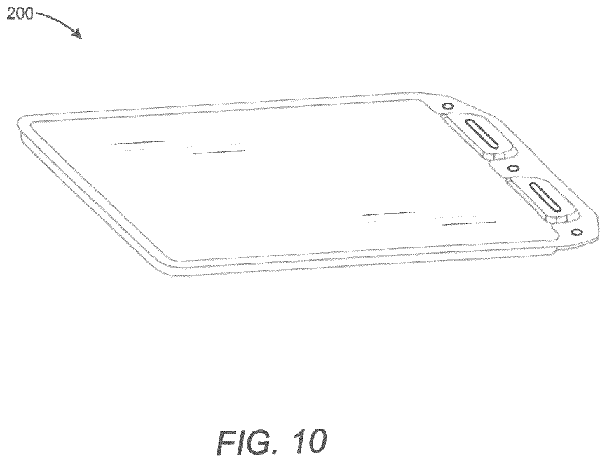

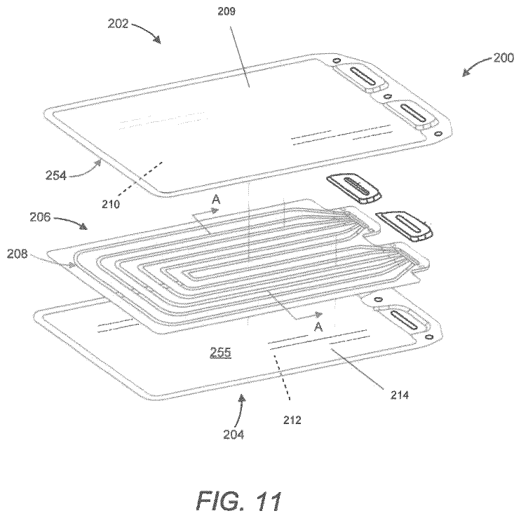

FIG. 10 illustrates another embodiment of a battery cooling pouch generally at 200. FIG. 11 is an exploded view of the battery cooling pouch 200. Battery cooling pouch 200 is similar to battery cooling pouch 100 previously described herein and similar elements are labeled with element numbers incremented by one hundred. Battery cooling pouch 200 provides for efficient and uniform cooling of a battery cell, such as a pouch battery cell. In one example, the battery cooling pouch 200 is used for cooling a lithium ion battery cell in an electric vehicle.

Battery cooling pouch 200 includes a first outer panel 202 and a second outer panel 204. The first outer panel 202 is defined as a cooling fin. The first outer panel 202 is configured to contact a battery cell. The second outer panel 202 can also be defined as a cooling fin. A cooling panel insert 206 is positioned between the first outer panel 202 and the second outer panel 204. The panel insert 206 includes cooling flow channels 208 to aid in moving coolant fluid through the battery cooling pouch 200 to aid in cooling the battery cell.

The first outer panel 202 and the second outer panel 204 operate to enclose the panel insert 206, allowing a coolant fluid to flow through the cooling flow channels 208 and/or through an interior compartment formed between first and second outer panels 202 and 204 of battery cooling pouch 200. The first outer panel 202 includes a first major surface 209 (facing away from panel insert 206) and a second major surface 210. The first major surface 209 is configured to contact the battery cell. The second outer panel 204 includes a first major surface 212 (facing away from panel insert 206) and a second major surface 214. The second outer panel 204 may also contact a battery cell at the second outer panel first major surface 212. In one embodiment, both of the first outer panel 202 first major surface 209 and the second outer panel 204 first major surface 212 are substantially planar to maximize contact surface area with a battery cell. The panel insert 206 is positioned between the first outer panel 202 and the second outer panel 204.

The first outer panel 202 and the second outer panel 204 are made of a generally rigid polymeric material or metal such as aluminum. Panel insert 206 is made of a generally rigid polymeric material. In one example, the first outer panel 202 is made of aluminum, and includes a formed well area 254 on the second major surface 210. Similarly, the second outer panel 204 includes a formed well area 255. When assembled, first outer panel 202 is secured to second outer panel 204 at their outer edges, such as by welding or an adhesive. In the assembled position, the panel insert 206 fits securely within the area formed by well areas 254 and 255. FIG. 12 illustrates one example cross-section of panel insert 206. In this example, panel insert 206 includes 6 channels spaced about the panel insert, indicated as 208a, 208b, 208c, 208d, 208e and 208f. The channels extend entirely through the panel insert 206. Alternatively, the channels may only extend partially through the panel insert 206 (illustrated by dashed grooves).

FIG. 13 is an expanded view illustrating another embodiment of a battery cooling panel generally at 100a that is similar to battery cooling pouch 100, and where like elements include the same element number with an “a” added. The first outer panel 102a is defined as a cooling fin. The first outer panel 102a is configured to contact a battery cell (not illustrated in FIG. 13). The second outer panel 104a can also be defined as a cooling fin. A panel insert 106a is positioned between the first outer panel 102 and the second outer panel 104. The panel insert 106a includes cooling flow channels 108a to aid in cooling the battery cell. In this embodiment, cooling flow channels 108a start and end on different sides of the panel insert 106a, and as such on different sides of the battery cooling pouch 100a. In this example, inlet channel endplate 130a is on one side of the panel insert 106a and outlet channel endplate 130b is at an opposite side of the panel insert 106a. There are eight separate cooling flow channels 108a illustrated, that generally form a circuitous or varied (i.e., not straight) path through the panel insert 106a from inlet channel endplate 130a to outlet channel endplate 132a to aid in maximizing and providing a uniform cooled surface in contact with a battery cell.

Other alternative embodiments for the battery cooling pouch illustrated in FIGS. 3-13 are contemplated without departing from the scope of the present disclosure. In one example, the battery cooling pouch includes first outer panel 102 secured directly to panel insert 106. In this example, panel insert 106 acts as both the panel insert with coolant flow channels and the second outer panel. Alternatively, the channels may not extend entirely through the panel insert. In this example, there may or may not be a need for a second outer panel. In another example, the battery cooling pouch includes a first outer panel and a second outer panel, where the coolant flow channels are formed integrally with the second outer panel. In this embodiment, the channel structure and also other parts such as the channel plate may be formed integrally the second outer panel.

FIG. 14 is an exploded view illustrating one embodiment of a battery module subassembly indicated generally at 300. The battery module subassembly 300 is suitable for use in an electric vehicle. One or more battery module subassemblies 300 may be combined (e.g., stacked) to form battery modules 500 illustrated schematically by FIG. 2. The battery module subassembly 300 includes a battery cooling pouch, such as battery cooling pouch 100, immediately adjacent one or more battery cells, such as battery cells 302 and 304. Battery module subassembly 300 further includes a manifold system for moving coolant fluid in and out of the battery module, and specifically through the battery cooling pouch 100 contained within the battery module subassembly. In this example, the battery cells 302, 304 are pouch battery cells such as a lithium ion battery cell. The battery cooling pouch 100 provides efficient cost-effective cooling of one or more battery cells. The present design takes advantage of a similar surface area at an interface between the major surfaces of the battery cooling pouch and the battery cell to improve cooling surface area.

Battery module subassembly 300 is in a stack configuration as illustrated. Battery module subassembly 300 includes battery cooling pouch 100. Battery cooling pouch 100 is positioned between a first battery cell 302 and a second battery cell 304, where battery cells 302 and 304 represent example implementations of battery cells 302 and 304 illustrated schematically by FIG. 2. Battery cell 302 and battery cell 304 are pouch battery cells. In one example, battery cells 302 and 304 are lithium ion battery cells. Battery cell 302 includes a first battery surface 306 and a second battery surface 308 (not shown). Second battery surface 308 is a generally planar battery surface. Battery cooling pouch 100 includes a generally planar first outer panel 102 immediately adjacent and having first outer panel first major surface 109 in contact with second battery surface 308 of battery cell 302. In one aspect, the cooling surface of first outer panel first major surface 109 is in substantially total contact with second battery surface 308 of battery cell 302. Similarly, battery cell 304 includes a first battery surface 310 and a second battery surface 312. First battery surface 310 of battery cell 304 is a generally planar battery surface. Battery cooling pouch 100 includes generally planar second outer panel 104 (not shown) immediately adjacent and having second outer panel first major surface 112 (not shown) in contact with first battery surface 310 of battery cell 304. In one aspect, the cooling surface of second outer panel first major surface 112 is in substantially total contact with first battery surface 310 of battery cell 304.

Battery module subassembly 300 further includes cartridge assembly 318. Cartridge assembly 318 securely retains first battery cell 302, cooling pouch 100 and second battery cell 304 together in order to maximize cooling efficiency and uniformity of the batteries by battery cooling pouch 100. In one example, cartridge assembly 318 is made of a relatively hard, lightweight polymeric material. Cartridge assembly 318 includes first frame member 320 and second frame member 322. The frame members 320, 322 are generally rectangular shaped and each include an outer wall 324, 326. A retention ledge 328, 330 extends inward from a corresponding outer wall 324, 326. When secured together at corners 340, retention ledges 328, 330 operate to securely retain the first battery cell 302, the battery cooling pouch 100, and the second battery cell 304 within battery module subassembly 300 (illustrated by retention directional arrows 342). Battery module subassembly 300 may further include one or more gaskets 350 to maintain fluid seals within the battery module.

A manifold system 360 is in fluid communication with battery module subassembly 300 for moving coolant fluid into and out of the battery module subassembly 300. In one aspect, each cartridge frame member 320, 322 include a cartridge frame manifold 362,364 having an opening in communication with manifold system 360 for bringing coolant fluid into and out of battery cooling pouch 100. In one mode of operation, coolant fluid flows from inlet manifold 370, into cartridge inlet manifold 372, and enters battery cooling pouch 100 inlet channel endplate 130 where coolant fluid accesses the panel insert channels 108 for cooling battery cells 302,304. The coolant fluid moves through the battery cooling pouch 100 channels 108 and/or through an interior compartment formed between first and second outer panels 102 and 104 and exits the cooling pouch 100 at outlet channel endplate 132 (not shown). Outlet channel endplate 132 is in fluid communication with cartridge outlet manifold where the coolant fluid exits the battery module via outlet manifold 374. Further, coolant fluid moves to additional battery modules via first frame member 320 and second frame member 322. Arrows illustrate a coolant fluid flow path through the battery module subassembly 300, at 384.

FIG. 15 generally illustrates one example of a battery module 500 for use in an EV, such as electric snowmobile 2, where battery module 500 represents an example implementation of battery module 500 as illustrated schematically by FIG. 2. In some embodiments, one or more battery modules 500 may be combined to form battery pack 54 as illustrated schematically by FIG. 2. The battery module 500 includes multiple stacked battery module subassemblies 300a, 300b and 300c connected together via their cartridge assemblies 318a, 318b and 318c. The battery module 500 may also include covers, plates or caps 390 at either end to protect and compress battery module subassemblies 300a, 300b and 300c there between. The manifold system 360 allows for coolant fluid to flow through the entire battery module 500 via the cartridge frame manifolds 362a, b, c and cartridge frame manifolds 364a, b, c. Battery connectors or electrodes in the form of blades 510 (positive and negative) are battery connection posts that extend from individual batteries located within the battery module. The battery module 500 couples to an EV drivetrain via the battery connectors 510.

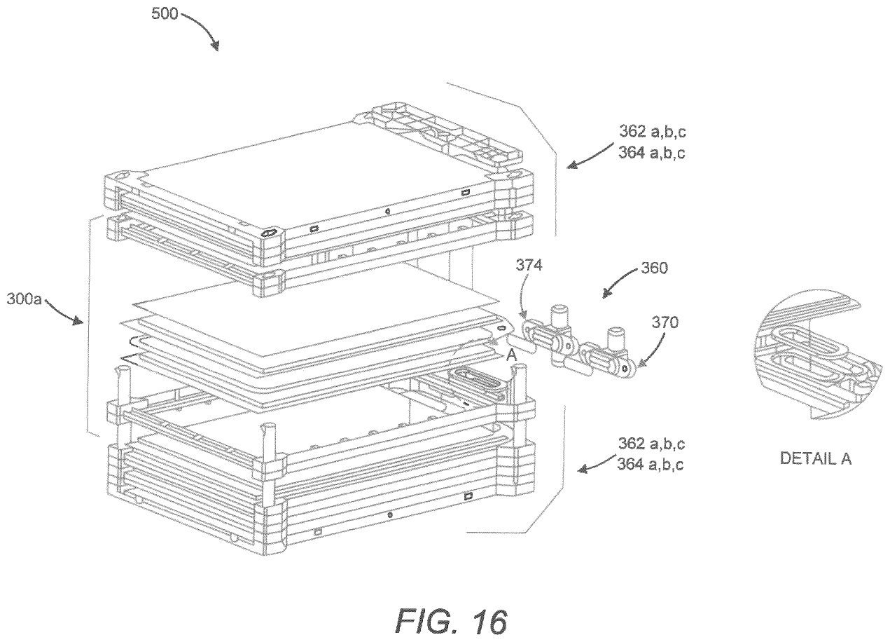

FIG. 16 is an expanded view of the battery module 500. As illustrated, a battery module subassembly 300a is illustrated as part of battery module 500. Further, manifold system 360 includes cartridge inlet manifold 370 and cartridge outlet manifold 374 in fluid communication with the cooling pouches located within the battery module 500. In this example, only one cartridge inlet manifold 370 and one cartridge outlet manifold 372 is needed to provide coolant fluid flow to and from the entire battery module 500. Coolant liquid flow is provided in and out of the cooling pouches via cartridge cooling manifolds 362a, b, c and 364a, b, c.

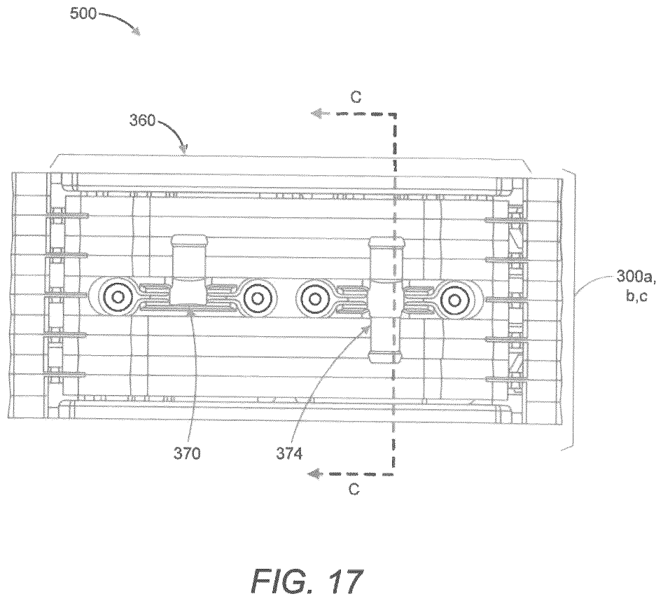

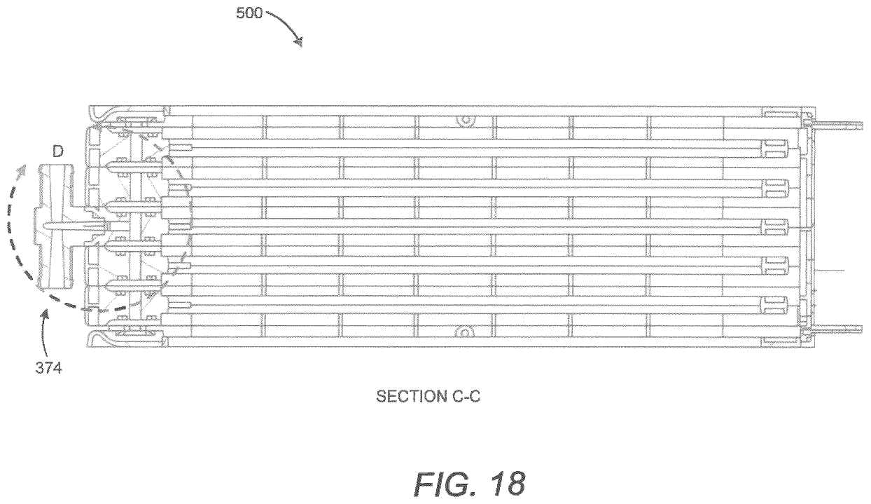

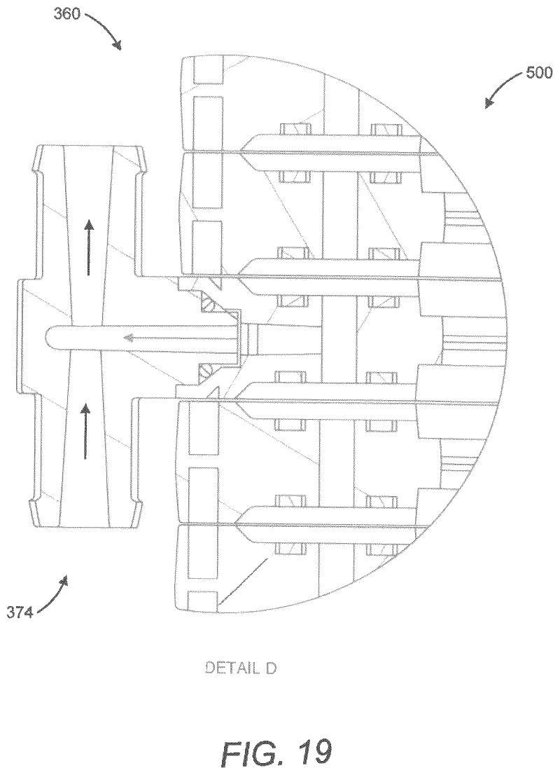

FIG. 17 is an end view of the battery module 500 illustrating the manifold system 360. FIG. 18 is a cross-section of battery module 500 along line C-C of FIG. 15. FIG. 19 is an enlarged partial view of the manifold system 360 as the coolant fluid flow path enters battery module 500.

Lithium-ion battery cells, such as battery cells 302 and 304, according to examples, are subject to performance degradation with time and usage (e.g., loss of capacity and decreased efficiency), where such degradation may result from various factors, such as a number of charging/discharging cycles, operating magnitude, operating temperature, an operating state-of-charge (SOC), and externally applied pressure. One particular characteristic of lithium-ion battery cells that can lead to damage over time is that battery cells expand and contract during operation, particularly in the thickness (Th) direction. If not addressed, such expansion and contraction can cause separation and delamination of battery cell layers leading to performance degradation and decreased battery life.

The primary cause of volumetric expansion and contraction of a lithium-ion battery cell is electrical charging and discharging of the cell, which causes movement of lithium ions across a separator between a metal oxide anode and a graphite cathode of the battery. For example, during a charging operation, an applied external voltage potential forces lithium ions to move across the separator from the metal oxide cathode to the graphite anode. The lithium ions bind to the graphite anode forming LiₓC₆, which increases the size of the anode and, thus, the overall volume of the battery cell, including its thickness, T_{H}. In examples, it has been found that, during a charging operation, when battery cells are constrained along their lateral sides but not in the direction of thickness, the thickness may potentially increase by as much as 1.6% when the state of charge is increased from 15% to 95% of charge capacity. Conversely the battery cell decreases in thickness as it discharges.

While not to the same extent as that caused by charging and discharging of the battery cell, battery cell operating temperature has also been found to affect battery cell thickness, where battery cell thickness increases with increasing temperature. In some cases, it has been found that at increased operating temperature, cell thickness may vary by as much as 0.2%.

It has been shown that increased external pressure on lithium-ion battery cells reduces expansion of battery cell thickness and extends the operating life of battery cells. In some cases, a pressure of 5 pounds per square inch (psi) or more across a battery cell may be sufficient to extend battery cell life. In other embodiments, a pressure greater than 5 psi (e.g., 10, 15, 20 or 50 psi) may be implemented to help further extend battery cell life.

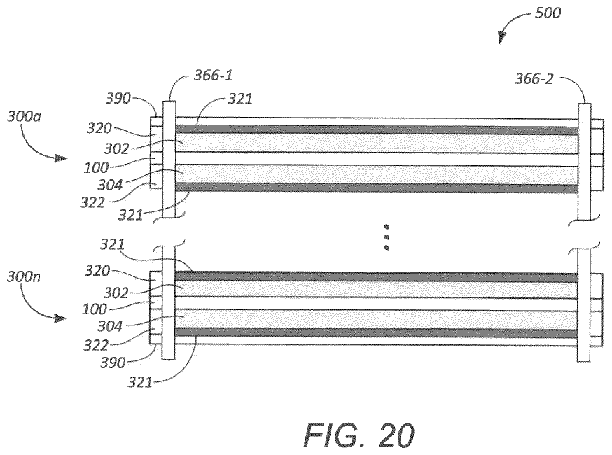

FIG. 20 is a block and schematic diagram generally illustrating a number of battery module subassemblies 300, illustrated as battery module subassemblies 300a to 300n, stacked upon one another to form a battery module 500, according to one example. According to examples, battery module subassemblies 300 are secured together via a number of frame retention elements 366, such as frame retention elements 366-1 and 366-2, which extend through frame members 320 and 322 of cartridge assembly 318 of each battery module subassembly 300. In examples, frame retention elements 366 (e.g., bars, rods, bolts, nuts, etc.) may extend through aligned openings 340 at each corner of battery module subassemblies 300 (e.g., see FIGS. 14-16) and engage with end caps 390.

In examples, when tightened, frame retention elements 366 draw caps 390 together to compress battery module subassemblies 300 of battery module 500. In examples, frame retention elements 366 hold battery module subassemblies 300 and the components thereof (e.g., cooling pouch 100 and battery cells 302 and 304) under a retention pressure, PR, to constrain volumetric expansion of battery cells 302 and 304, and to hold battery cells 302 and 304 in contact with a corresponding side of cooling pouch 100 to provide efficient heat transfer there between. In some examples, battery module subassemblies 300 include foam layers 321 disposed between upper and lower frame members 320 and 322 and adjacent battery cells 302 and 304 to cushion contact there between.

In other examples, battery module subassemblies 300 do not include foam layers 321 between upper and lower frame members 320 and 322. Accordingly, within battery module 500, battery cell 304 of one subassembly 300a would be in direct contact with battery cell 302 of adjacent subassembly 300b. Within a battery module 500, the cells and cooling pouches of stacked subassemblies 300 may have following pattern: battery cell, cooling pouch, battery cell, battery cell, cooling pouch, battery cell, battery cell, cooling pouch, battery cell, for example. This arrangement of battery cells and cooling pouches provides that each battery cell is in contact with a cooling pouch, such that the cooling pouch is able to extract heat from one or more battery cells, while also providing a relatively uniform pressure to the battery cell.

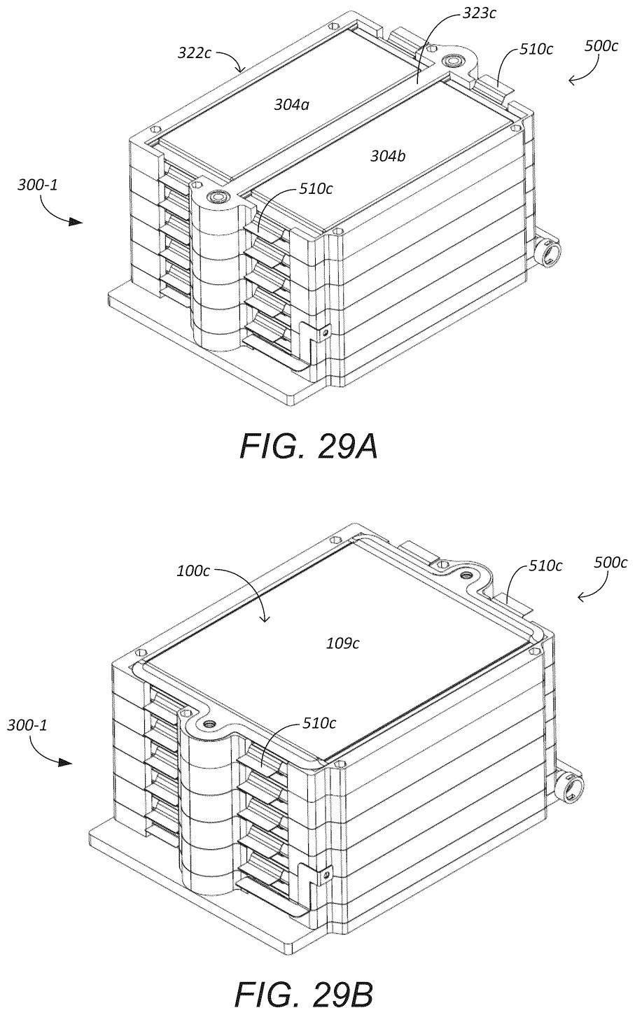

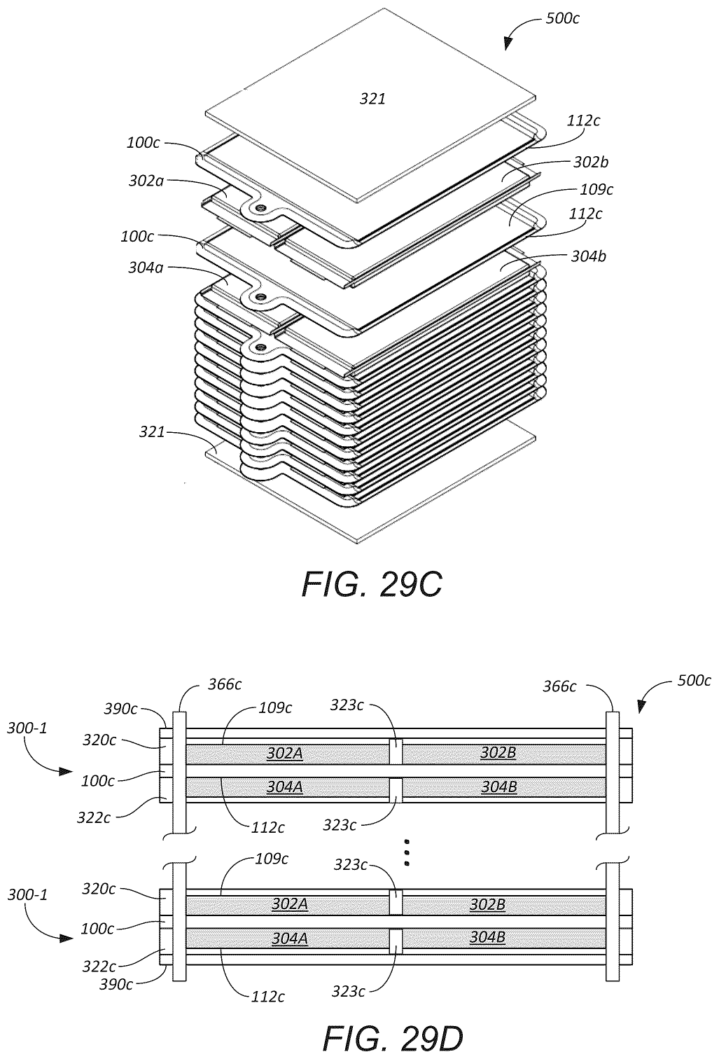

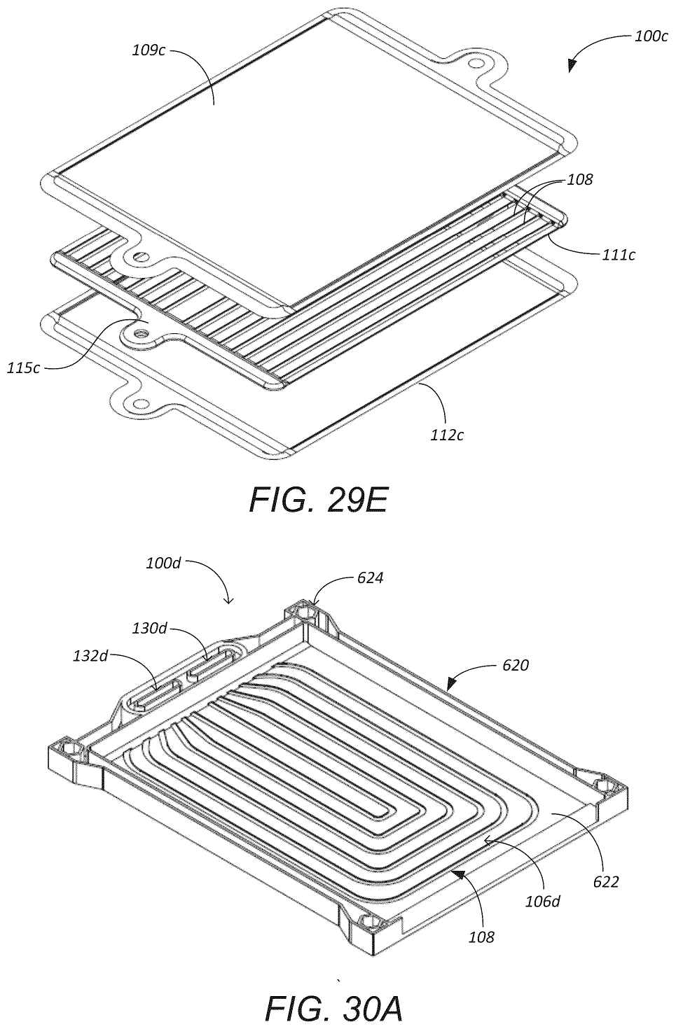

In other examples, a foam layer 321 may be included next to the end caps 390, but nowhere else within battery module 500. As such, within a battery module 500, the cells and cooling pouches may have the following pattern: battery cell, cooling pouch, battery cell, cooling pouch, battery cell, cooling pouch, etc. This arrangement of battery cells and cooling pouches provides that each battery cell is in contact with a cooling pouch on both sides (i.e. against both of its major surfaces), which may be beneficial for a thicker battery cell that benefits from cooling from both sides. The foam layers 321 at each end of the battery module 500 against the end caps 390 provides mechanical stability to the cells prior to thermal fluid being provided to the battery module 400. One example of such an implementation is provided below by FIG. 29C.

The frame retention elements 366 provide an example of retention elements to apply a retention pressure to a battery stack including multiple cooling pouches 100 and battery cells. Other examples are also contemplated. For example, frame retention elements may be provided externally to a stack of multiple battery modules 500 to compress the battery modules 500 there between.

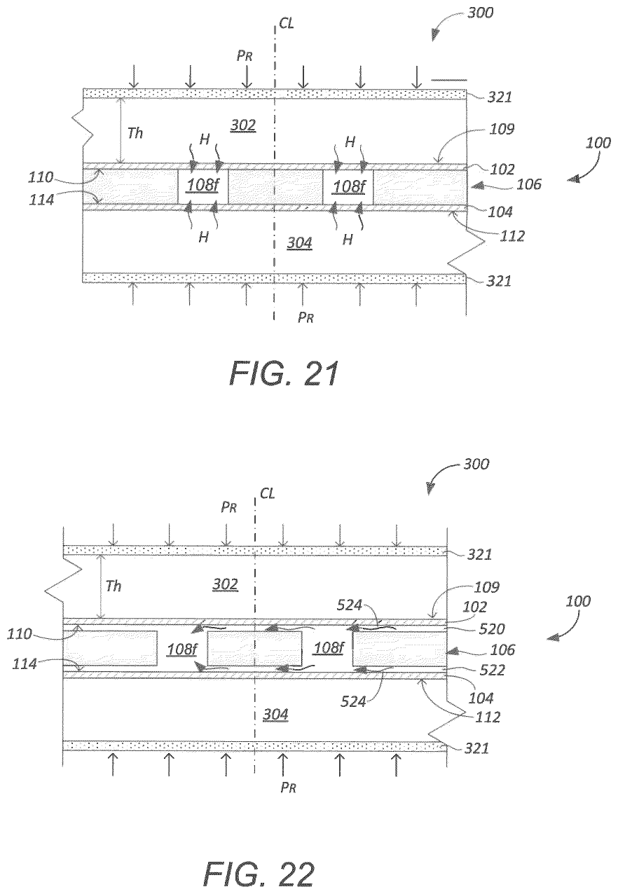

FIG. 21 is a block and schematic diagram generally illustrating a cross-sectional view of a portion of a battery module subassembly 300 of battery module 500 of FIG. 20, according to one example. Retention pressure, P_{R}, exerted by frame retention elements 366 (see FIG. 22) respectively forces battery cells 302 and 304 against the exterior surfaces 109 and 112 of first and second outer panels 102 and 104 of cooling pouch 100. In addition to constraining battery cells 302 and 304 to decrease expansion, such pressure also acts to ensure close and uniform contact between battery cells 302 and 304 and the thin and flexible first and second outer panels 102 and 104 of cooling pouch 100 to provide effective heat transfer, H, from battery cells 302 and 304 to coolant fluid (e.g., glycol) circulated through cooling flow channels 108.

As will be described further below, in addition to retention pressure P_{R}, fluid pressure P_{F} from within the cooling pouches 100 further ensures close and uniform contact between battery cells 302 and 304 and the first and second outer panels 102 and 104 of the cooling pouch 100. Given that the cooling pouches have some level of flexibility, by controlling the fluid pressure from within the cooling pouches 100, the cooling pouches 100 may be made to expand/contract to compensate for expansion/contraction in the battery cells 302 and 304 during charging/discharging cycles. This allows for uniform and close contact between the battery cells 302, 304 and the cooling pouch 100 throughout the discharging operation, and throughout the life of the battery pack.

In FIG. 21, with further reference to FIGS. 4 and 12, it is noted that flow channel 108f extends directly adjacent to and along both sides of longitudinal centerline, CL, of cooling panel insert 106, between inlet channel endplate 130 and outlet channel endplate 132 (see FIG. 4), such that, in FIG. 21, coolant fluid flows in a direction out of the page on the right-hand side of centerline, CL, and in a direction into the page on the left-hand side of centerline, CL. In examples, as illustrated, cooling flow channels 108 may be rectangular in shape with a first set of opposing interior sidewalls formed by panel insert 106, and a second set of opposing sidewalls, which are in contact with battery cells 302 and 304, being formed by the interior surfaces 110 and 114 of first and second outer panels 102 and 104 of cooling pouch 100. In other examples, cooling flow channels may have cross-sectional shapes other than rectangular.

As described above, in examples (e.g., with reference to FIG. 5-9), first and second outer panels 102 and 104 of cooling pouch 100 are light-weight, flexible, thin-film or foil sheets between which panel insert 106 is disposed. In one example, first and second outer panels 102 and 104 are sealed together along their perimeter edges (e.g., heat-sealed) to form an interior compartment in which panel insert 106 is disposed and is free-floating. In another case, panel insert 106 is secured between first and second outer panels 102 and 104 via sealing of their perimeter edges to perimeter edges of opposing surfaces 116 and 118 of panel insert 106. Such construction of cooling pouch 100 enables surfaces 109 and 112 of flexible panels 102 and 104 to adapt and conform to surfaces of battery cells 302 and 304 to ensure substantially uniform contact and heat transfer therebetween.

With reference FIG. 22, while the flexibility of first and second outer panels 102 and 104 enables uniform contact with battery cells 302 and 304, during operation, such flexibility may also enable gaps, such as gaps 520 and 522, to form between interior surfaces 110 and 114 of panels 102 and 104 and upper and lower surfaces 116 and 118 of panel insert 106. For example, gaps 520 and 522 may form due to contraction of battery cells 302 and 304 during electrical discharge, or due to non-uniform contact between the battery cells 302 and 304 and surfaces 109 and 112 of cooling pouch 100 during operation.

As coolant fluid is circulated through cooling flow channels 108, including cooling flow channel 108f, gaps 520 and 522 enable the cross-flow of coolant fluid to between adjacent cooling flow channels, as illustrated by arrows 524. For example, as illustrated by FIG. 22, coolant fluid may migrate from adjacent cooling flow channels 108e to cooling flow channels 108f (e.g., see FIGS. 4 and 12), and from the portion of cooling channel 108f extending along one side of longitudinal centerline, CL, to the portion of cooling channel 108f extending along the other side of longitudinal centerline, CL. In some examples, coolant fluid may migrate transversely between cooling flow channels 108 relative to longitudinal centerline, CL, such that a volume of coolant fluid may flow via gaps 520 and 522 between inlet and outlet channel endplates 130 and 132 without passing through a full length of cooling flow channels 108 of cooling pouch 100 (e.g., at least partially short-circuiting the cooling flow channels 108). As a result, the flow of coolant fluid though cooling flow channels 108 may be non-uniform throughout cooling pouch 100, with some areas getting more coolant flow than other areas, thereby leading to uneven cooling of battery cells 302 and 304. For example, regions of cooling pouch 100 along edges opposite inlet and outlet channel endplates 130 and 132 may receive less coolant flow than regions proximate to inlet and outlet channel endplates 130 and 132. Such uneven cooling may potentially result in regions of battery cells 302 and 304 being undercooled which, in-turn, can result in increased volumetric expansion of the battery cells in such regions and potentially lead to localized delamination of battery cell layers.

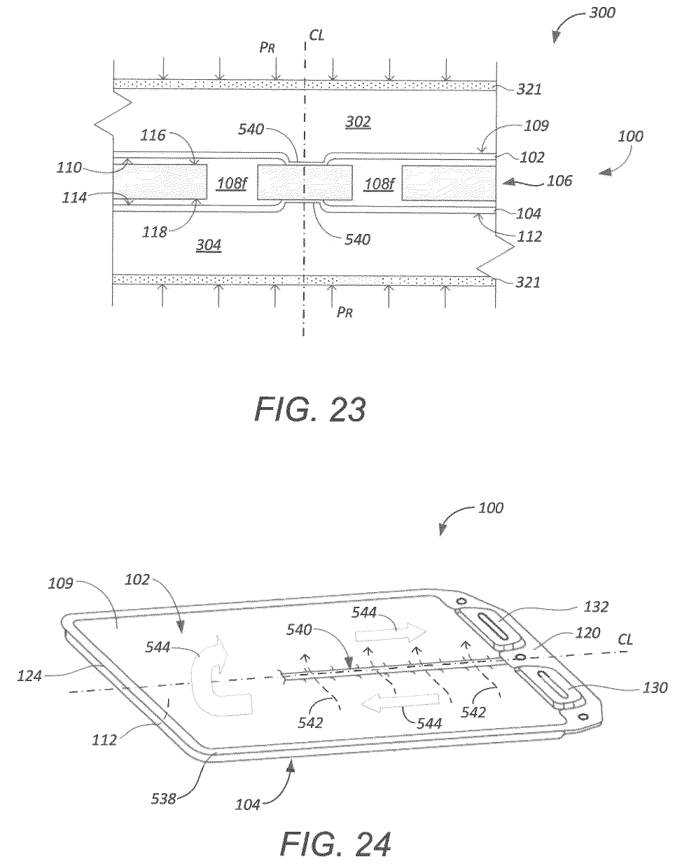

FIGS. 23 and 24 respectively illustrate a cross-sectional view of a portion of a battery module subassembly 300 of battery module 500, and a perspective view of battery cooling pouch 100 including battery module subassembly 300 of FIG. 23, according to one example of the present disclosure. According to one example, in addition to a seal 538 (e.g., a heat seal) between perimeter edges of first and second outer cooling panels 102 and 104 and, in some cases, between perimeter edges of first and second outer cooling panels 102 and 104 and the perimeter edge of panel insert 106, at least one additional seal 540 is made between the interior surfaces 110 and 114 of first and second outer panels 102 and 104 and upper and lower surfaces 116 and 118 of panel insert 106 at an interior region of panel insert 106 of cooling pouch 100 (i.e., away from the perimeter edges) to reduce the amount of cross-flow of coolant fluid between adjacent cooling flow channels 108 and thereby provide a more uniform flow of coolant fluid through battery cooling pouch 100.

In one example, as illustrated by FIG. 24, seal 540 is disposed along a portion of the longitudinal centerline, CL, of panel insert 106 to prevent the cross-flow of coolant fluid from cooling flow channels 108 extending from inlet channel endplate 130 toward cooling flow channels 108 extending towards the output channel endplate 132 without travelling towards the edge 124, as indicated by the dashed arrows 542. In one example, as illustrated, seal 540 extends along longitudinal centerline, CL, from edge 120, proximate to inlet and outlet channel endplates 130 and 132, to a location where channels 108 extend transversely to longitudinal centerline, CS (e.g., see FIG. 4). As illustrated, seal 540 cross-flow of coolant fluid between cooling fluid channels 108 on opposite sides of longitudinal centerline, CS, and causes coolant fluid to flow generally along the path of cooling fluid channels 108 between inlet and outlet channel endplates 130 and 132, as illustrated by flow arrows 544, to thereby provide improved uniformity of coolant fluid flow through battery cooling pouch 100 and, thus, improved uniformity of cooling of battery cells 302 and 304.

Although illustrated and described as having only one longitudinally extending seal 540 made between outer panels 102 and 104, in other examples, more than one longitudinally extending seal may be formed. For example, in some cases, additional longitudinal seals may be made in parallel with longitudinal seal 540 disposed between cooling flow channels at locations between the longitudinal centerline, CL, and longitudinal edges of battery cooling pouch 100, where such additional seals further reduce cross-flow between cooling flow channels 108 having cooling liquid flowing in a same direction. In some cases, such additional longitudinally extending seals are disposed at interior locations of battery cooling pouch 100 (i.e., spaced from edges 120 and 124). In some cases, such additional longitudinally extending seals may be disposed at locations more prone to cross-flow between cooling flow channels 108 (e.g., proximate to outlet channel endplate 132, locations where cooling flow channels change directions from parallel to transverse to longitudinal centerline, CL). In examples, a length of longitudinal seal 540 may vary based on an amount of cross-flow to be prevented. In examples, first and second outer panels 102 and 104 may be mechanically or electrically joined to panel insert 106 to form seals 540 using suitable techniques, such as by welding, heat sealing, or with an adhesive, for example.

In the illustrated example of FIGS. 23-24, channels 108 are illustrated as extending entirely through panel insert 106. In other examples, channels 108 may extend only partially through panel insert 106.

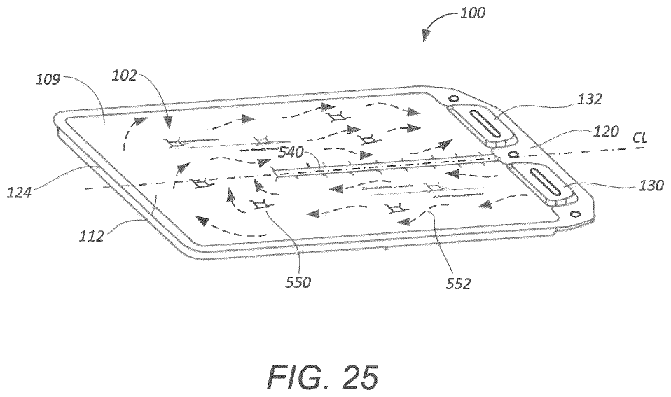

In another example, as illustrated by FIG. 25, in addition to, or in lieu of, seal 540, a plurality of smaller seals 550, also referred to as micro seals 550, may be made between the inner surfaces 110 and 114 of first and second outer panels 102 and 104 and surfaces 116 and 118 of panel insert 106. In examples, micro seals 550 are disposed at locations to direct and disperse the flow of coolant fluid within panel insert 106, as illustrated by the dashed flow arrows 552. The micro seals 550 may direct flow in a manner to improve flow distribution and uniformity of cooling of battery cells 302 and 304. In examples, micro seals 550 may be positioned to direct a desired volume of coolant fluid to regions that might otherwise receive less coolant fluid flow, such as to corners of cooling pouch 100. In examples, micro seals 550 may be positioned to create turbulent or non-uniform flow (non-laminar flow) within cooling pouch 100 to improve heat transfer. In examples, such micro seals 550 may be of varying sizes and/or disposed at varying densities (i.e., the number of seals in a given area) to control and direct desired volumes of coolant fluid to different regions of cooling pouch 100, and to adjust the quality of the fluid flow to achieve improved heat transfer.

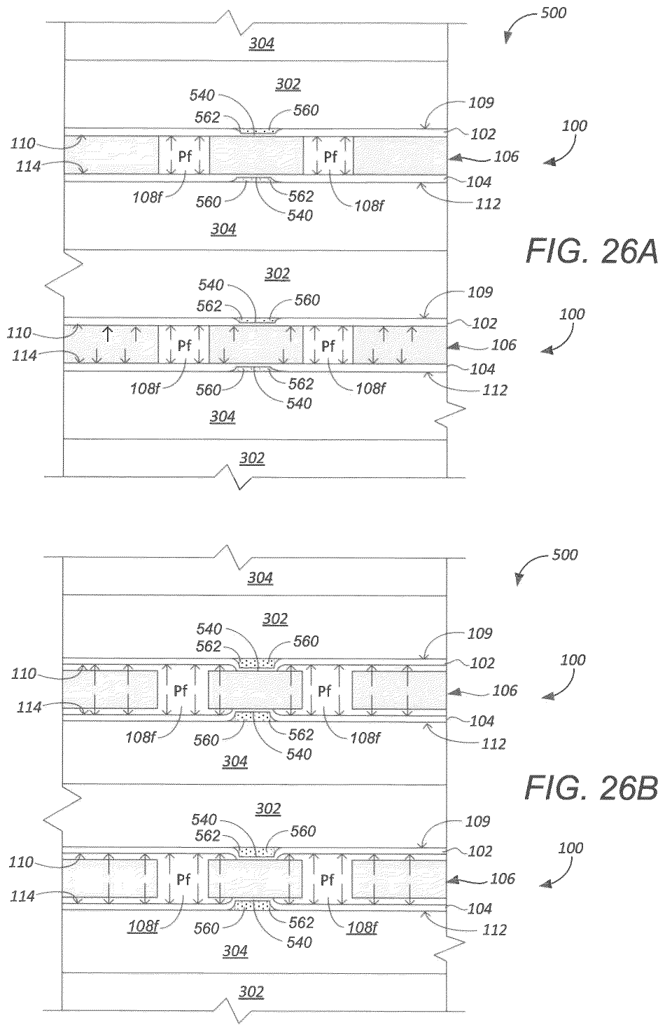

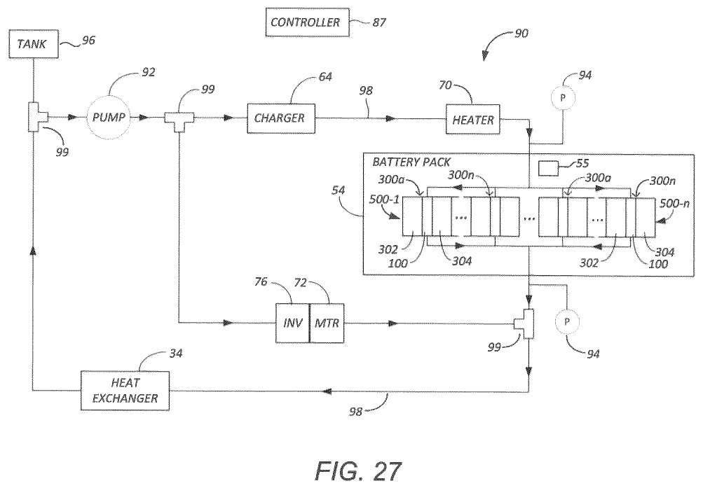

With reference to FIGS. 26A, 26B, and 27, according to examples of the present disclosure, thermal management system 90 (see FIG. 27) is implemented and operated to dynamically regulate the fluid pressure, P_{F}, of the coolant fluid of cooling panels 100 to provide and maintain a substantially constant pressure on at least one side of battery cells 302 and 304 as the battery cells vary in thickness during operation (i.e., volumetrically expand and contract). By dynamically regulating the fluid pressure, P_{F}, of the cooling fluid, the cooling fluid and cooling pouch 100 act as structural elements to maintain a substantially constant pressure on battery cells 302 and 304 to reduce adverse effects associated with the expansion and contraction of battery cells 302 and 304 during operation (e.g., to reduce the occurrence of layer delamination). Additionally, a constant pressure on battery cells 302 and 304 maintains direct contact between first and second outer panels 102 and 104 to provide efficient heat transfer with battery cells 302 and 304.

FIGS. 26A and 26B are block and schematic diagrams illustrating a cross-sectional view of a portion of battery module 500 including battery modules subassemblies 300a and 300b, according to one example. FIG. 26A illustrates battery cells 302 and 304 as being in an expanded state where inner surfaces 110 and 114 of first and second outer panels 102 and 104 are in contact with panel insert 106, while FIG. 26B illustrates battery cells 302 and 304 in a contracted state where inner surfaces 110 and 114 of first and second outer panels 102 and 104 are spaced from panel insert 106 with gaps 520 and 522 present there between.

In the example of FIGS. 26A and 26B, it is noted that battery module 500 does not include foam layers 321 between adjacent battery module subassemblies 300 (e.g., see FIG. 20) so that surfaces of battery cells 302 and 304 of adjacent battery module subassemblies are in direct contact with one another, or so that surfaces of battery cells 302 and 304 are in direct contact on either side with a cooling pouch 100. In examples, the absence of such foam layers 321 enables a more consistent pressure to be applied to opposing sides of battery cells 302 and 304, including by retention elements 366 (see FIG. 20) and by fluid pressure of cooling pouches 100. In one example, as illustrated, a foam insert or strip 560 is positioned within a recess 562 formed in surfaces 109 and 112 of first and second outer panels 102 and 104 by seal 540, wherein the foam insert 560 is configured to reduce and/or eliminate potential deformation of battery cells 302 and 304 which might otherwise be caused by portions of batter cells being forced into and conforming to a shape of recess 562 (due to seal 540), where such deformation could potentially lead to localized delamination of battery layers.

In one example, thermal management system 90 operates to maintain fluid pressure, P_{F}, of the coolant fluid at constant operating pressure level which is at least equal to a fluid pressure to prevent the flexible thin-film of first and second outer panels 102 and 104 from being pushed at least partially into cooling flow channels 108 by expansion of battery cells 302 and 304. If first and second outer panels 102 and 104 partially collapse into fluid channels 108, such collapse can result in non-uniform coolant flow between different cooling pouches 100 of a same battery module subassembly 300, between different battery module subassemblies 300 of a same battery module 500, and between different battery modules 500 of a same battery pack 54 (e.g., see FIG. 2). Such uneven flow of coolant fluid may result in uneven temperature control and performance differences between battery module subassemblies 300 and battery modules 500 throughout battery pack 54 and cause potential shortening of an expected operational life of battery pack 54 or limit operation of snowmobile 2 if battery cell overheating limits the amount of power that can be safely drawn from battery pack 54.

In some examples, the fluid pressure, P_{F}, is greater than or equal to 5 psi. In some examples, the fluid pressure, P_{F}, is greater than or equal to 10 psi. In some examples, the fluid pressure, P_{F}, is greater than or equal to 15 psi. In some examples, the fluid pressure, P_{F}, is greater than or equal to 20 psi. Other examples of the fluid pressure, P_{F}, are also contemplated.

With reference to FIG. 27, in accordance with the present disclosure, thermal management system 90 may employ a number of techniques for maintaining the fluid pressure, P_{F}, of coolant fluid within cooling flow channels 108 of cooling pouches 100 at a at selected operating fluid pressure level to at least prevent first and second outer panels 102 and 104 from collapsing into cooling flow channels 108, and/or to maintain or increase the thickness of cooling pouch 100 and/or to maintain a relatively constant pressure from the cooling pouches to the battery cells. Such techniques include operating pump 92 at a speed or at a duty cycle required to generate a fluid pressure at the selected operating fluid pressure level within cooling flow channels 108 or across the surface 110 and 114 of the cooling pouch 100.

In examples, a selected operating fluid pressure level of thermal management system 90, and in particular for battery pack 54, is a known value determined during design and manufacture of electric vehicle 2. In one example, during operation of electric vehicle 2, pump 92 is operated at a fixed rotational speed and/or duty cycle to create a fluid pressure, P_{F}, of cooling fluid within thermal management system 90 that is at least equal to the selected operating fluid pressure level. In one example, pump 92 is operated at a fixed rotational speed and/or duty cycle to create a fluid pressure, P_{F}, of cooling fluid within thermal management system 90 that is greater than the selected operating fluid pressure level. In one example, pump 92 is operated at a fixed rotational speed and/or duty cycle to create a fluid pressure of cooling fluid within thermal management system 90 that is greater than the selected operating fluid pressure level by a predetermined percentage, such as 150%. In one example, if the selected operating fluid pressure level has been determined to be approximately 5 pounds per square inch (psi), for instance, a size, duty cycle and operational speed (rpm) of pump 92 may be selected to generate and circulate the coolant fluid at a fluid pressure, P_{F}, of 10 psi. In other examples, the operating fluid pressure, P_{F}, of the coolant pressure generated by pump 92 may have any number of values.

In other examples, in lieu of operating pump 92 at a predetermined fixed speed and/or duty cycle, pressure gauges 94 may be disposed in fluid pathway 98 at an inlet and/or at an outlet to battery pack 54, wherein controller 87 (see FIG. 2) adjusts an operating speed and/or duty cycle of pump 92 based on a pressure value provided by pressure gauge(s) 94 to maintain the pressure, P_{F}, of the coolant fluid at the selected operating fluid pressure level. For example, when the pressure gauge 94 indicates a drop in fluid pressure, P_{F}, the pump 92 may provide additional output power to provide additional fluid pressure.

While a pressure gauge may be used to provide a control feedback for operation of the pump 92, in alternative examples, the control system may adjust fluid pressure based on different inputs. As the battery cells go through a discharge cycle, their thickness reduces. Similarly, as the battery cells age and degrade, their thickness increases. Accordingly, a control system may adjust the fluid pressure P_{F}, within the cooling pouches 100 by controlling operation of the pump 92. More specifically, control algorithms may adjust the operation of the pump 92 to adjust fluid pressure, P_{F}, based on factors (i.e. battery operating parameters) such as battery state of charge (SOC), indications of age/health of the battery cells, indication of cumulative operating hours of the battery pack, indication of voltage variance across battery cells in the battery pack, and indication of battery cell temperatures within the battery pack (such as battery cells 302 and 304 of battery pack 54), for example.

In examples, a controller, such as controller 87, is operative to control one of a speed and a duty cycle of pump 92 on the basis of an identified battery operating parameter to maintain the selected operating pressure level. In examples, the controller 87 is operative to increase one of a duty cycle and speed of pump 92 to maintain the selected operating pressure level as the plurality of battery cells discharge. In other examples, controller 87 is operative to decrease one of a duty cycle and speed of pump 92 to maintain the selected operating pressure level as the plurality of battery cells degrade in health.

For example, based on a detected SOC of the battery pack 54, a control system may cause the pump 92 to adjust the fluid pressure within the cooling pouches 100. For example, a controller may cause the pump 92 to operate in a manner to increase and/or decrease the fluid pressure based on SOC or battery age in order to maintain a constant pressure on the battery cells and compensate for thicker or thinner states of the battery cells.

By operating to maintain a fluid pressure, P_{F}, of coolant fluid at a pressure level at least equal to a selected operating fluid pressure level to maintain a substantially constant external pressure of battery cells 302 and 304, thermal management system 90, in accordance with examples of the present disclosure, reduces potential structural degradation of battery cells 302 and 304 associated with battery cell expansion and contraction during operation (e.g., cell layer degradation), and extends an operating life of battery cells 302 and 304 and, thus, an operating life of battery pack 54.

In some embodiments, the configuration of the thermal management system 90 (as shown in FIGS. 2 and 27, for example) may help increase coolant fluid pressure in the battery pack 54, and thereby increase coolant fluid pressure in fluid channels 108 of cooling pouches 100 in general. For example, battery pack 54 may be positioned relatively close to the high-pressure outlet of pump 92, which may provide a relatively high fluid pressure at the inlet to battery pack 54. In the illustrated example, battery pack 54 is positioned downstream of the outlet of pump 92 and upstream of the inlet of heat exchanger 34 in the first fluid circulation loop (i.e., between the outlet of pump 92 and the inlet of heat exchanger 34). This configuration may increase pressure in battery pack 54 as the pressure drop across heat exchanger 34 occurs downstream of battery pack 54.

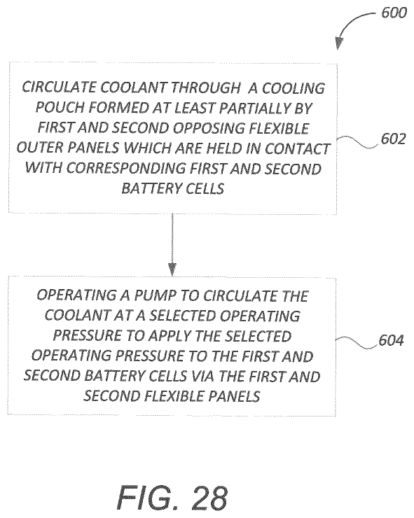

FIG. 28 is a flow diagram that generally illustrates a method 600 of operating a thermal management system of an electric vehicle, such as thermal management system 90 of electric vehicle 2. In one example, method 600 begins at 602, with circulating coolant fluid within a cooling pouch (such as through a plurality of cooling flow channels within the cooling pouch) of the thermal management system. At least a portion of the cooling flow channels may be formed by first and second opposing flexible outer panels of the cooling pouch, such as first and second outer panels 102 and 104 of cooling pouch 100. The first and second opposing flexible outer panels are held in direct contact with corresponding first and second battery cells, such as cooling panels 102 and 104 of cooling pouch 100 being held in contact with first and second battery cells 302 and 304 (such as illustrated by FIGS. 14 and 16).

At 604, method 600 includes operating a pump of the thermal management system to circulate the coolant fluid at a selected operating fluid pressure level to apply the selected operating fluid pressure level to the first and second battery cells via the first and second opposing flexible outer panels of the cooling pouch. For example, pump 92 of the thermal management system circulates coolant at a selected operating pressure level, Pf, through cooling flow channels 108 and/or through cooling pouch 100 to apply the selected operating pressure to battery cells 302 and 304 via flexible first and second outer panels 102 and 104 of cooling pouch 100 (such as illustrated by FIG. 26A/B and 27).

FIGS. 29A-29D generally illustrate a battery module 500c, according to one example of the present disclosure, where FIGS. 29A, 29B and 29C are perspective views of battery module 500c with certain components removed and in an exploded view, and FIG. 29D is a block and schematic diagram generally illustrating a cross-sectional view of battery module 500a. FIG. 29E is an exploded view of one example of a cooling pouch 100 suitable for use with battery module 500c.

According to examples, battery module 500c includes a plurality of battery module subassemblies 300-1, similar to battery module subassemblies 300 of FIG. 14, which are stacked on top of one another in a manner similar to that illustrated by FIGS. 15 and 16. However, in contrast to battery module subassembly 300 of FIG. 14, where cooling pouch 100 is sandwiched between single battery cells 302 and 304 by upper and lower frame members 320 and 322, each cooling pouch 100c (see FIG. 29B) of battery module subassembly 300-1 is sandwiched between two pairs of battery cells that are positioned side by side, with a first pair of battery cells 302a and 302b being disposed in contact with external surface 109c of cooling pouch 100c, and a second pair of battery cells 304a and 304b being disposed in contact with external surface 112c of cooling pouch 100c. As such, each cooling pouch 100c of battery module 500c cools four battery cells (i.e., 302A, 302B, 304A, and 304B), as compared to cooling panels 100 and 100a of FIGS. 14 and 15 which cool two battery cells (i.e., battery cells 302 and 304).

In examples, upper and lower frame members 320c and 322c each respectively hold first pair of battery cells 302a and 302b, and second pair of battery cells 304a and 304b. In one example, upper and lower frame members 320c and 322c each include a central frame element 323c to separate the corresponding pair of battery cells. Retention elements 366c draw together end caps 390c to compress the components of battery module subassemblies 300-1. In one example, when cooling pouch 100 as illustrated by FIGS. 24 and 25 is employed with battery module 500c, interior seal 540 aligns with central frame element 323c such that foam insert 560 (see FIGS. 26A and 26B) may not be required to prevent battery cell deformation. With reference to FIG. 29C, battery module 500c includes a cooling pouch 100c positioned between each pair of battery cells 302A/302B and 304A/304B, such that each cooling pouch 100c cools a surface of four battery cells, and each battery cell contacts a cooling pouch 100c on each of its major surfaces so that it is cooled on both sides.

According to examples, battery module 500c may include battery cells 304A, 304B that include positive and negative blades 510c on opposite edges of the cells as shown in FIG. 29B. In an example implementation shown in FIG. 29E, cooling pouch 100c may include an insert panel 111c with channels 108 that extend from one edge of the pouch to the other edge of the pouch (i.e in a relatively straight fashion, and not in a U-shaped arrangement). There may be any suitable number of cooling flow channels 108 that form a path through the panel insert (e.g. circuitous or varied or straight path) from an inlet channel endplate (not shown) to outlet channel endplate 115c to aid in maximizing and providing a uniform cooled surface in contact with battery cells 304A, 304B. In some examples, the cooling pouch 100c may include one or more seals (such as seal 540) between the cooling flow channels to avoid cross-flow between cooling flow channels. The seals may be formed by mechanically or chemically joining a portion of the interior surfaces of first and second outer panels of the cooling pouches with upper and lower surfaces of their panel inserts.

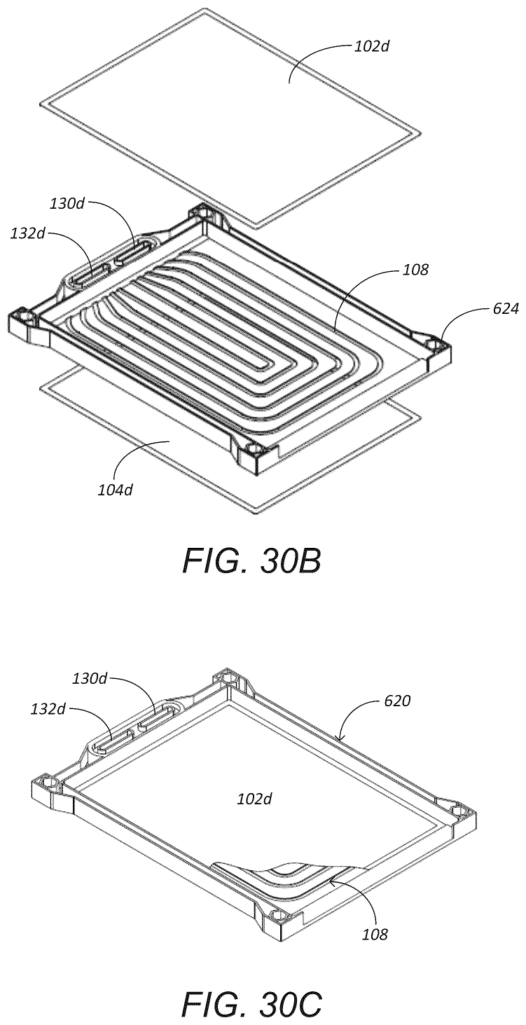

FIG. 30A is a perspective view illustrating an implementation of a cooling pouch 100d, according to one example of the present disclosure. As illustrated, cooling pouch 100d includes a frame member 620 having an inlet channel endplate 130d and an outlet channel endplate 132d. A panel insert 106d having a plurality of grooves 108 extending at least partially therethrough is integrally formed with the frame member 620. The grooves 108 extend in a generally U-shaped manner between inlet channel endplate 130d and outlet channel endplate 132d. Alternatively, the grooves 108 can be of any suitable shape or pattern that provides the desired thermal behavior. For example, the grooves 108 can be linear (extending from one end of the panel insert 106d to the other end), circuitous, wavey or concentric, among other possibilities. Dimples, or divets, or other regions of interference may be included within the grooves to provide more turbulent fluid flow.

As illustrated by line 622, perimeter edges of a flexible outer panel 102d may be sealed (e.g., thermally sealed) about perimeter edges of panel insert 106d, wherein flexible outer panel 102d seals against panel insert 106 to transform groves 108 into cooling flow channels 108 (in a manner similar to that described by FIGS. 3-9). In a case where grooves 108 extend through panel insert 106d, a flexible outer panel 104d, shown in FIG. 30B, is sealed over panel 106d on the opposing side of frame member 600 and panel 106d. In examples, at each corner, frame member 620 includes openings for retention elements to pass therethrough, as illustrated by retention opening 624. FIG. 30C shows flexible outer panel 102d in position over panel 106d, with a corner cut away to show channels 108 underneath.

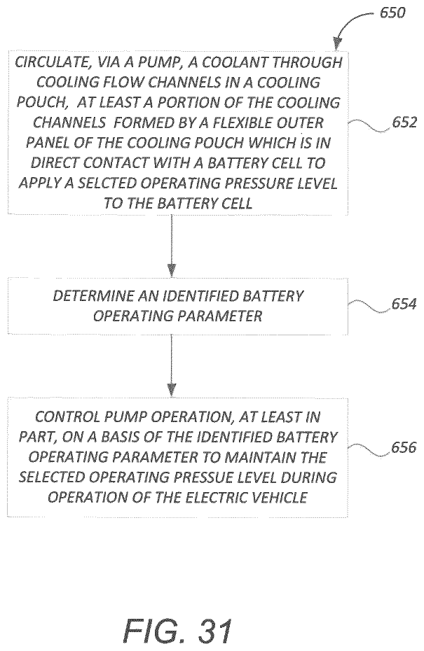

FIG. 31 is a flow diagram that generally illustrates a method 650 of operating a thermal management system of an electric vehicle (such as thermal management system 90 of electric vehicle 2). In one example, method 650 begins at 652 with circulating, via a pump a coolant fluid through a plurality of cooling flow channels in a cooling pouch (such as cooling flow channels 108 in cooling pouch 100) of the thermal management system. At least a portion of the cooling flow channels are formed by a flexible outer panel of the cooling pouch (such as flexible outer panel 102 of cooling pouch 100), the flexible outer panel being in direct contact with a battery cell for applying a selected operating pressure level to the battery cell (such as flexible outer panel 102 being in direct contact with battery cell 302 for applying a coolant fluid pressure, PF).

At 654, method 650 includes determining an identified battery operating parameter (such as determining a temperature of battery cells 302 and 304, and a pressure of coolant fluid via pressure sensors 94). At 656, method 650 includes controlling operation of a pump (such as pump 92) at least in part on a basis of the identified battery operating parameter to maintain the selected operating pressure level during operation of the electric vehicle.

In examples, determining an identified battery operating parameter includes determining at least one of a fluid pressure reading, an indication of a vehicle state of charge (SoC), an indication of battery cell age, an indication of cumulative operating hours on the battery, and indication of voltage variance across battery cells within the battery pack, and an indication of battery cell temperature within the battery pack. In examples, controlling operation of the pump includes at least one of adjusting a speed and a duty cycle of the pump on the basis of the identified battery operating parameter.

Although specific examples have been illustrated and described herein, a variety of alternate and/or equivalent implementations may be substituted for the specific examples shown and described without departing from the scope of the present disclosure. For example, as mentioned above, although a thermal management system in accordance with the present disclosure is primarily illustrated and described with respect to an electric snowmobile, it is noted that the thermal management system described herein is suitable for use with other types of electric vehicles, including automotive electric vehicles (e.g. electric cars, vans and trucks) and various EPVs such as, for example, ATVs, UTVs, and electric motorcycles among other possibilities. This application is intended to cover any adaptations or variations of the specific examples discussed herein.

1. A battery cooling pouch comprising:
a first thin film sheet defined as a first cooling fin having a first major surface to contact a battery cell;
a second thin film sheet defined as a second cooling fin having a first major surface; and
a panel insert of a polymeric material, wherein perimeter edges of the first and second thin film sheets are sealed to confine the panel insert between the first and second thin film sheets, the panel insert having a major surface defining coolant flow grooves exposed to the first thin film sheet to form coolant flow channels;
wherein the cooling pouch comprise at least one interior seal between at least a portion of the first thin film sheet and the major surface of the panel insert to direct a coolant fluid through the coolant flow channels.

2. The cooling pouch of claim 1, wherein the at least one interior seal eliminates a cross-flow of coolant fluid between at least two adjacent coolant flow channels.

3. The cooling pouch of claim 1, wherein the at least one interior seal extends along a portion of a centerline of the panel insert and eliminates a cross-flow of coolant fluid between coolant flow channels on opposite sides of the centerline.

4. The cooling pouch of claim 1, wherein the cooling pouch includes an inlet channel endplate and outlet channel endplate disposed along a common edge of the cooling pouch, wherein the coolant flow channels extend in a U-shaped manner across the major surface of the panel insert between the inlet channel endplate and output channel endplate, wherein a longitudinal centerline of the panel insert extends from common edge to an opposing edge, and wherein the at least one interior seal extends along the longitudinal centerline from the common edge to a location where the U-shaped coolant flow channels extend transversely to the longitudinal centerline.

5. The cooling pouch of claim 1, including a plurality of interior seals between the second major surface of the first thin film sheet and the major surface of the panel insert to direct coolant fluid in a uniform manner through the plurality of coolant flow channels.

6. The cooling pouch of claim 1, wherein the panel insert is more rigid relative to the first and second thin film sheets.

7. The cooling pouch of claim 1, wherein perimeter edges of the first and second major surfaces of the first and second thin film sheets are sealed directly to one another to form a compartment in which the panel insert is located.

8. The cooling pouch of claim 1, wherein a perimeter edge of the first major surface of the first thin film sheet is sealed directly to a perimeter edge of the major surface of the panel insert, and a perimeter edge of the second major surface of the second thin film sheet is sealed directly to a perimeter edge of an opposing major surface of the panel insert.

9. An electric vehicle comprising:
a battery including:
a plurality of battery cells;
a plurality of cooling pouches interleaved with the plurality of battery cells, each cooling pouch having opposing first and second thin-film walls, at least one of the first and second thin-film walls of each cooling pouch being in contact with at least one battery cell; and
a pump to circulate a coolant fluid through the cooling pouches at a selected operating pressure level to apply the selected operating pressure via the cooling pouches to at least one battery cell in contact there with.

10. The electric vehicle of claim 9, wherein the electric vehicle further comprises a controller operative to control operation of the pump to maintain the selected operating pressure level during operation of the electric vehicle at least in part on a basis of an identified battery operating parameter.

11. The electric vehicle of claim 10, wherein the selected operating pressure level comprises a predetermined constant pressure range.

12. The electric vehicle of claim 11, wherein the identified battery operating parameter comprises at least one of a fluid pressure reading, an indication of a vehicle state of charge (SOC), an indication of a vehicle age, an indication of cumulative vehicle operating hours, an indication of voltage variance across battery cells within the battery, an indication of battery cell temperature within the battery.

13. The electric vehicle of claim 12, wherein the controller is operative for controlling one of a speed and a duty cycle of the pump on a basis of the identified battery operating parameter to maintain the selected operating pressure level.

14. The electric vehicle of claim 12, wherein the controller is operative to increase one of a duty cycle and speed of the pump as the plurality of battery cells discharge to maintain the selected operating pressure level.

15. The electric vehicle of claim 12, wherein the controller is operative to decrease one of a duty cycle and speed of the pump as the plurality of battery cells degrade in health to maintain the selected operating pressure level.

16. The electric vehicle of claim 9, wherein each cooling pouch includes a panel insert disposed between the opposing first and second thin-film walls, the panel insert defining a plurality of coolant flow grooves exposed to the first thin-film wall to form coolant flow channels, wherein the pump circulates the coolant fluid through the coolant flow channels.

17. The electric vehicle of claim 12, further including:
a pressure gauge to measure of a pressure level of the coolant fluid at an inlet to the battery to provide the fluid pressure reading.

18. A method of operating a thermal management system of an electric vehicle comprising:
circulating, via a pump, coolant fluid through a plurality of cooling flow channels in a cooling pouch of the thermal management system, wherein at least a portion of the cooling flow channels are formed by a flexible outer panel of the cooling pouch, the flexible outer panel being in direct contact with a battery cell for applying a selected operating pressure level to the battery cell; and
determining an identified battery operating parameter;
controlling operation of the pump at least in part on a basis of the identified battery operating parameter to maintain the selected operating pressure level during operation of the electric vehicle.

19. The method of claim 18, wherein determining an identified battery operating parameter comprises determining at least one of: a fluid pressure reading, an indication of a vehicle state of charge (SOC), an indication of a vehicle age, an indication of cumulative vehicle operating hours, an indication of voltage variance across battery cells within the battery, an indication of battery cell temperature within the battery.

20. The method of claim 19, wherein controlling operation of the pump comprises at least one of one of adjusting a speed and a duty cycle of the pump on a basis of the identified battery operating parameter.
